(19) United States
(12) Patent Application Publication
(10) Pub. No.: US 2013/0209111 A1
(43) Pub. Date: Aug. 15, 2013

(54) DEMODULATING DELAY CIRCUIT AND OPTICAL RECEIVER

(71) Applicant: Furukawa Electric Co., Ltd., (US)

(72) Inventors: Hiroshi Kawashima, Tokyo (JP); Kazutaka Nara, Tokyo (JP)

(73) Assignee: Furukawa Electric Co., Ltd., Tokyo (JP)

(21) Appl. No.: 13/840,997

(22) Filed: Mar. 15, 2013

Related U.S. Application Data
(63) Continuation of application No. PCT/JP2012/066171, filed on Jun. 25, 2012.

(30) Foreign Application Priority Data
Sep. 12, 2011 (JP) 2011-198818

(51) Int. Cl. G02F 2/00

(52) U.S. Cl. CPC G02F 2/00
USPC 398/202; 359/325

(57) ABSTRACT

A demodulating delay circuit with a planar lightwave circuit includes: an optical interferometer including input and output couplers, and a first arm waveguide connecting the couplers, and a shorter second arm waveguide. The interferometer delays each bit of a signal by one bit such that the delayed bit interferes with its adjacent bit, and has a bent form such that propagation directions of light in the couplers are different by 180 degrees. The couplers each include first and second waveguides. The first waveguide is longer and the waveguides are closely arranged in parallel at two positions thereby forming directional couplers. The input and output couplers are each configured as a wavelength insensitive coupler having a coupling ratio of 50 percent in a bandwidth used. The first waveguide of the input coupler is arranged on the same side as that on which the first waveguide of the output coupler is arranged.

### CROSS-REFERENCE TO RELATED APPLICATIONS

This application is a continuation of PCT International Application No. PCT/JP2012/066171 filed on Jun. 25, 2012 which claims the benefit of priority from Japanese Patent Application No. 2011-198818 filed on Sep. 12, 2011. The entire contents of the PCT international application and the Japanese patent application are incorporated herein by reference.

### BACKGROUND OF THE INVENTION

1. Field of the Invention

The present invention relates to a demodulating delay circuit of which a planar lightwave circuit that demodulates a phase-modulated optical signal is formed on a PLC chip, and to an optical receiver that uses the same.

2. Description of the Related Art

In differential quadrature phase shift keying (DQPSK) communication systems having a transmission speed of 40 Gbps or differential phase shift keying (DPSK) communication systems, PLC demodulating delay circuits are used as demodulating elements that demodulate D(Q)PSK optical signals, PLC demodulating delay circuits of which their delay circuits are formed of waveguide optical interferometers such as Mach-Zehnder interferometers (MZIs) that use silica-based planar lightwave circuits (PLCs) (see JP 4615578 B1). This PLC demodulating delay circuit is configured by coupling both ends of two delay line waveguides having a predetermined optical path length difference by optical couplers having a coupling ratio of 50% (hereinafter, referred to as a coupler). The easiest method is to use, as the coupler, a 2×2 (two inputs×two outputs) directional coupler (DC) configured by bringing two waveguides close to each other.

For such a PLC demodulating delay circuit, a high extinction ratio of 20 dB or more, for example, is necessary to obtain sufficient light reception sensitivity.

However, when using a usual directional coupler as a coupler, there is a problem that it is difficult to ensure an extinction ratio of 20 dB or more over the entire range (CL band) from C band (approximately 1525 to 1565 nm) to an L band (approximately 1565 to 1620 nm) used in optical communications. The extinction ratio of 20 dB or more means that an absolute value of the extinction ratio is 20 dB or more.

The extinction ratio of the MZI is known to drastically fall when a coupling ratio of the coupler deviates from 50%.

Generally, when a coupling ratio of a coupler is κ and a phase difference between two delay line waveguides is Δφ, coupling ratios (transmittances) ηth and ηcr of a through port and a cross port of a MZI are expressed by the following equations (1) and (2).

$$\begin{matrix}{η}_{th} = {( 1 - 2 κ )}^{2} {cos}^{2} ( \frac{Δ Φ}{2} ) + {sin}^{2} ( \frac{Δ Φ}{2} ) & ( 1 ) \\ {η}_{cr} = 4 κ ( 1 - κ ) {cos}^{2} ( \frac{Δ Φ}{2} ) & ( 2 )\end{matrix}$$

According to equation (2), the coupling ratio ηcr of the cross port where Δφ=(2M+1)π (M is an integer), which is a condition for extinction in the cross port, is zero regardless of the coupling ratio of the coupler, and thus, a high extinction ratio is obtainable.

Further, according to equation (1), when the coupling ratio of the coupler deviates from 50%, the coupling ratio ηth of the through port where Δφ=2Mπ, which is a condition for extinction in the through port, is not zero. For example, if the coupling ratio when the coupling ratio of the coupler κ is increased by 5% from 50% is ηth′, the following equation (3) is obtained.

$${η}_{th}^{′} = {( 1 - 2 \times 0.55 )}^{2} {cos}^{2} ( \frac{2 M π}{2} ) + {sin}^{2} ( \frac{2 M π}{2} ) ≅ 0.01 \qquad ( 3 )$$

Furthermore, if ηth′ is converted to transmittance Tth, the following equation (4) is obtained.

Tₜₕ=10 log(ηₜₕ)≅−20 dB (4)

It can thus be understood that, for the extinction ratio to be 20 dB or more, only an amount of change in the coupling ratio κ of ±5% is allowable.

With a normal directional coupler, a coupling ratio κ changes by approximately ±10% over CL band, and the coupling ratio κ changes also due to a manufacture error in an interval between waveguides of an optical coupling unit, and thus, it is difficult to ensure an extinction ratio of 20 dB or more.

Furthermore, such a PLC demodulating delay circuit has a balanced receiver or the like connected to each of two output waveguides of the MZI, for example, and is embedded in a receiver as a reception front end part to be used. Accordingly, miniaturization of the PLC demodulating delay circuit and the reception front end part is demanded in order to miniaturize the receiver.

Accordingly, there is a need to provide a modulating delay circuit, which has a high extinction ratio over a wide wavelength bandwidth, and an optical receiver using the same.

### SUMMARY OF THE INVENTION

According to an aspect of the present disclosure, a demodulating delay circuit in which a planar lightwave circuit that demodulates an optical signal that has been phase-modulated is formed, includes: a first optical interferometer including a two-input two-output input coupler, a two-input two-output output coupler, a first arm waveguide connecting the input coupler and the output coupler, and a second arm waveguide having an optical path length shorter than that of the first arm waveguide, the optical interferometer configured to cause interference by delaying each bit of the optical signal that has been input by approximately one bit such that the delayed bit interferes with a bit adjacent thereto. The first optical interferometer has a bent form such that a propagation direction of light in the input coupler differs from a propagation direction of light in the output coupler by approximately 180 degrees, the input coupler and the output coupler each include a first waveguide and a second waveguide, the first waveguide having an optical path length longer than that of the second waveguide, the first waveguide and the second waveguide being arranged in parallel at two positions in a longitudinal direction with a close distance between the first and second waveguides thereby forming a first directional coupler and a second directional coupler, the input coupler and the output coupler each configured as a wavelength insensitive coupler having a coupling ratio of approximately 50 percent in a wavelength bandwidth used, and the first waveguide of the input coupler is arranged on the same side, with respect to a longitudinal direction of the input coupler, as that on which the first waveguide of the output coupler is arranged with respect to a longitudinal direction of the output coupler.

Further, according to another aspect of the present disclosure, an optical receiver includes: the demodulating delay circuit; and a photodetector that receives, and converts into an electrical signal, an optical signal output from the demodulating delay circuit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a planar view illustrating a schematic configuration of a demodulating delay circuit according to a first embodiment;

FIG. 2 is a block diagram illustrating a schematic configuration of an optical transport system that uses DQPSK scheme;

FIG. 3 is a schematic view illustrating a configuration of an input coupler which is a WINO;

FIG. 4 is a diagram illustrating a calculated value of wavelength dependence of a coupling ratio κ of an input coupler which is a WINO;

FIG. 5 is a diagram illustrating a calculated value of wavelength dependence of a coupling ratio κ of a regular 50 percent directional coupler;

FIG. 6A is a view illustrating an example of an arrangement relationship between an input coupler and an output coupler with respect to a first MZI;

FIG. 6B is a view illustrating an example of an arrangement relationship between an input coupler and an output coupler with respect to the first MZI;

FIG. 6C is a view illustrating an example of an arrangement relationship between an input coupler and an output coupler with respect to the first MZI;

FIG. 6D is a view illustrating an example of an arrangement relationship between an input coupler and an output coupler with respect to the first MZI;

FIG. 7A is a diagram illustrating a calculated value of a transmission spectrum of the first MZI where an arrangement A is assumed;

FIG. 7B is a diagram illustrating a calculated value of a transmission spectrum of the first MZI where an arrangement B is assumed;

FIG. 7C is a diagram illustrating a calculated value of a transmission spectrum of the first MZI where an arrangement C is assumed;

FIG. 7D is a diagram illustrating a calculated value of a transmission spectrum of the first MZI where an arrangement D is assumed;

FIG. 8 is a view illustrating arrangements of fabricated output couplers;

FIG. 9 is a diagram illustrating a measured value of wavelength dependence of a coupling ratio κ of a fabricated output coupler of each arrangement;

FIG. 10 is a cross-sectional view along line X-X in FIG. 1;

FIG. 11 is a cross-sectional view along line Y-Y in FIG. 1;

FIG. 12 is a diagram illustrating transmission characteristics of a delay demodulation device;

FIG. 13A is a diagram illustrating transmission spectra near 1525 nm of output ports 1 and 2 of a delay demodulation device of an example;

FIG. 13B is a diagram illustrating transmission spectra near 1570 nm of the output ports 1 and 2 of the delay demodulation device of the example;

FIG. 13C is a diagram illustrating transmission spectra near 1610 nm of the output ports 1 and 2 of the delay demodulation device of the example;

FIG. 14A is a diagram illustrating transmission spectra near 1525 nm of output ports 1 and 2 of a delay demodulation device of a comparative example;

FIG. 14B is a diagram illustrating transmission spectra near 1570 nm of the output ports 1 and 2 of the delay demodulation device of the comparative example;

FIG. 14C is a diagram illustrating transmission spectra near 1610 nm of the output ports 1 and 2 of the delay demodulation device of the comparative example;

FIG. 15 is a diagram illustrating a measurement result of a PDF of each MZI of the delay demodulation device of the example in a wavelength band from 1520 to 1620 nm;

FIG. 16A is a diagram illustrating transmission spectra near 1520 nm of output ports 1 and 2 of the MZI of the arrangement A illustrated in FIG. 6A;

FIG. 16B is a diagram illustrating transmission spectra near 1570 nm of the output ports 1 and 2 of the MZI of the arrangement A illustrated in FIG. 6A;

FIG. 16C is a diagram illustrating transmission spectra near 1620 nm of the output ports 1 and 2 of the MZI of the arrangement A illustrated in FIG. 6A;

FIG. 17A is a diagram illustrating transmission spectra near 1520 nm of output ports 1 and 2 of the MZI of the arrangement B illustrated in FIG. 6B;

FIG. 17B is a diagram illustrating transmission spectra near 1570 nm of the output ports 1 and 2 of the MZI of the arrangement B illustrated in FIG. 6B;

FIG. 17C is a diagram illustrating transmission spectra near 1620 nm of the output ports 1 and 2 of the MZI of the arrangement B illustrated in FIG. 6B;

FIG. 18A is a diagram illustrating transmission spectra near 1520 nm of output ports 1 and 2 of the MZI of the arrangement C illustrated in FIG. 6C;

FIG. 18B is a diagram illustrating transmission spectra near 1570 nm of the output ports 1 and 2 of the MZI of the arrangement C illustrated in FIG. 6C;

FIG. 18C is a diagram illustrating transmission spectra near 1620 nm of the output ports 1 and 2 of the MZI of the arrangement C illustrated in FIG. 6C;

FIG. 19A is a diagram illustrating transmission spectra near 1520 nm of output ports 1 and 2 of the MZI of the arrangement D illustrated in FIG. 6D;

FIG. 19B is a diagram illustrating transmission spectra near 1570 nm of the output ports 1 and 2 of the MZI of the arrangement D illustrated in FIG. 6D;

FIG. 19C is a diagram illustrating transmission spectra near 1620 nm of the output ports 1 and 2 of the MZI of the arrangement D illustrated in FIG. 6D;

FIG. 20 is a diagram illustrating a relationship between a crossing angle and a crossing loss;

FIG. 21 is a diagram illustrating a relationship between a waveguide interval and a PDF;

FIG. 22 is a planar view illustrating a schematic configuration of a demodulating delay circuit according to a second embodiment;

FIG. 23 is a planar view illustrating a schematic configuration of a demodulating delay circuit according to a third embodiment;

FIG. 24A is a planar view illustrating a schematic configuration of a conventional delay demodulation device;

FIG. 24B is an enlarged view of input/output ends of the delay demodulation device illustrated in FIG. 24A;

FIG. 25 is a diagram illustrating, with respect to the conventional delay demodulation device illustrated in FIG. 24A, wavelength dependence of a PDF where there is a difference between PDFs of first and second MZIs; and

FIG. 26 is a diagram illustrating a change in the coupling ratio of a WINC when ΔL is changed.

### DETAILED DESCRIPTION OF THE PREFERRED EMBODIMENTS

Hereinafter, embodiments of a demodulating delay circuit according to the present disclosure will be described in detail with reference to the drawings. The present invention is not limited by these embodiments. Further, the same or corresponding elements in the drawings are denoted with the same reference numerals as appropriate. Furthermore, it is to be noted that the drawings are schematic, and that the relation between the thickness and the width of each layer, the proportion of each layer, and the like may be different from those of the actual. A portion may be included whose dimensional relations or proportions differ among the drawings.

### First Embodiment

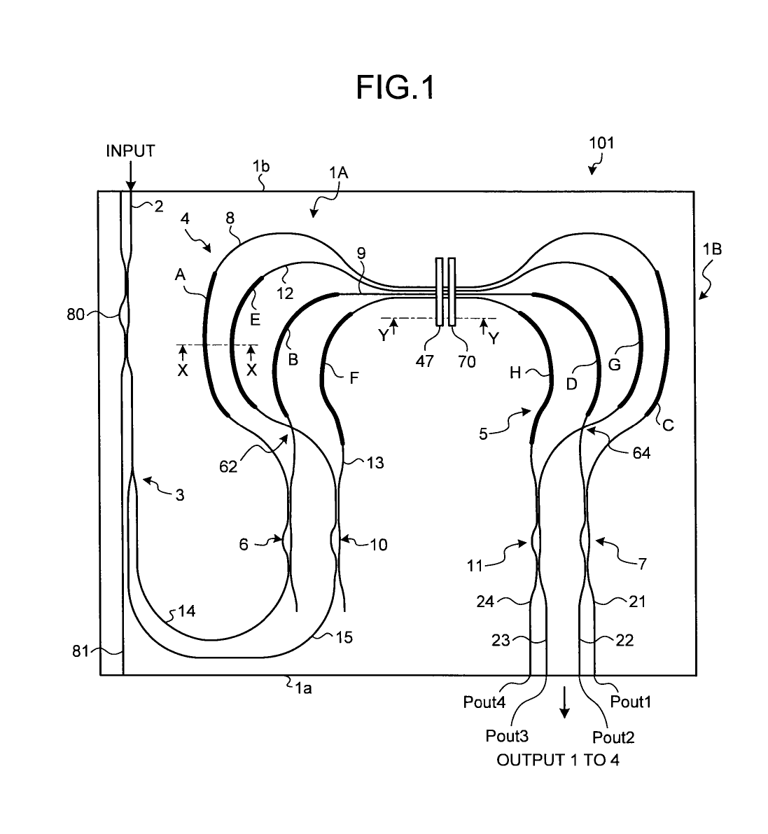

FIG. 1 is a planar view illustrating a schematic configuration of a demodulating delay circuit according to a first embodiment. A demodulating delay circuit 101 illustrated in FIG. 1 is a planar lightwave circuit (PLC) delay demodulation device having a planar lightwave circuit 1A formed of silica based glass or the like for demodulating an optical signal which has been DQPSK-modulated (a DQPSK signal) on one PLC chip 1B. This PLC demodulating delay circuit (hereinafter, referred to as a delay demodulation device) 101 is a delay demodulation device for 40 Gbps DQPSK which is used in an optical transport system that uses DQPSK scheme where the transmission speed is 40 Gbps, for example.

Additionally, in the present specification, the “delay demodulation device 101” that is used in an optical transport system that uses a DQPSK modulation scheme refers to a device that divides a DQPSK signal into two, converts the DQPSK signals obtained by dividing into light of intensity-modulated signals (optical intensity signals) by delaying each of the DQPSK signals by one bit by two MZIs and causing the same to interfere with each other, and outputs the four optical intensity signals obtained by conversion (I channels and Q channels) to four photodetectors of two pairs of balanced receivers. That is, the “delay demodulation device 101” of the present specification is an optical demodulator for demodulating DQPSK signals, formed of one PLC chip to be used in an optical transport system that uses a DQPSK modulation scheme and not including a balanced receiver.

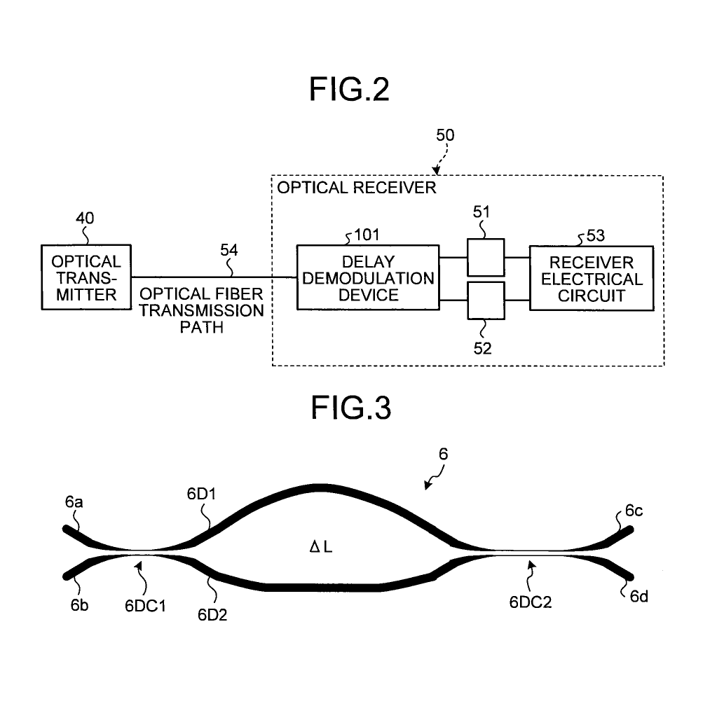

FIG. 2 is a block diagram illustrating a schematic configuration of the optical transport system that uses a DQPSK scheme. With the optical transport system illustrated in FIG. 2, an optical transmitter 40 transmits to an optical fiber transmission path 54 a DQPSK signal in which four pieces of information, i.e. values (0, 1, 2, 3) of symbols each formed from 2-bit data, are modulated according to a change in the values of two adjacent symbols into phase information of phases (θ, θ+π/2, θ+π, θ+3π/2) of a carrier wave. That is, the DQPSK signal includes contents of two bits so that the phase of light in one symbol (time slot) is any of four values (¼π, 3π/4, 5π/4, 7π/4). Accordingly, transmission data is able to be demodulated at an optical receiver 50 by detecting the phase difference between two adjacent symbols (any of phase differences 0, π/2, π, and 3π/2).

The DQPSK signal transmitted from the optical fiber transmission path 54 to the optical receiver 50 is converted into four optical intensity signals by the delay demodulation device 101 illustrated in FIG. 1, and then, the optical intensity signals are output to four photodetectors of balanced receivers 51 and 52 and are converted into electrical signals. A decoding process or the like is performed at a receiver electrical circuit 53.

Referring back to FIG. 1, the configuration of the delay demodulation device 101 will be described. The delay demodulation device 101 includes an optical input waveguide 2 to which a DQPSK signal is input, a tap coupler 80 that splits 5% of an optical signal propagated through the optical input waveguide 2 to a monitor output waveguide 81 to monitor the optical power of the input DQPSK signal by a monitor PD, a Y-branch waveguide 3 as an optical divider that approximately equally divides the rest of the optical signal which has not been divided by the tap coupler 80, and a first Mach-Zehnder interferometer (MZI) 4 and a second Mach-Zehnder interferometer (MZI) 5 that delay each of the DQPSK signals which have been divided by the Y-branch waveguide 3 by one bit. Additionally, the monitor PD is connected to the monitor output waveguide 81. Moreover, the split ratio of the tap coupler 80 in the first embodiment is 5%, and the ratio is preferably 20% or less, and more preferably, from 5 to 10%.

The delay demodulation device 101 further includes a first ½ wavelength plate 47 and a second ½ wavelength plate 70, and has crossing points 62 and 64 of the waveguides, and explanation thereof will be given later.

The first MZI 4 includes an input coupler 6 that is connected to a waveguide 14 that is connected to one of the output sides of the Y-branch waveguide 3, an output coupler 7 having two output ends connected to two optical output waveguides 21 and 22, respectively, and two arm waveguides (a first arm waveguide 8 and a second arm waveguide 9) that are delay waveguides of different lengths connected between both of the couplers 6 and 7. Likewise, the second MZI 5 includes an input coupler 10 that is connected to a waveguide 15 that is connected to the other output side of the Y-branch waveguide 3, an output coupler 11 having two output ends connected to two optical output waveguides 23 and 24, respectively, and two arm waveguides (a first arm waveguide 12 and a second arm waveguide 13) of different lengths that are delay waveguides connected between both of the couplers 10 and 11.

The input couplers 6 and 10 and the output couplers 7 and 11 are each a two-input two-output, 50 percent coupler. One of the two input ends of the input coupler 6 of the first MZI 4 is connected to the waveguide 14. One of the two input ends of the input coupler 10 of the second MZI 5 is connected to the waveguide 15.

Also, the first and second arm waveguides 8 and 9 of the first MZI 4 are formed, being bent in such a way that the propagation direction of light in the input coupler 6 and the propagation direction of light in the output coupler 7 are different by approximately 180 degrees. Similarly, the first and second arm waveguides 12 and 13 of the second MZI 5 are formed, being bent in such a way that the propagation direction of light in the input coupler 10 and the propagation direction of light in the output coupler 11 are different by approximately 180 degrees. Specifically, in FIG. 1, the propagation direction of light in the input couplers 6 and 10 is the upward direction on the page, and the propagation direction of light in the output couplers 7 and 11 is the downward direction on the page.

Additionally, in the present first embodiment, the waveguide 14 is connected to the input end of the input coupler 6 on the left side on the page, and the waveguide 15 is also connected to the input end of the input coupler 10 on the left side on the page. However, the waveguide 14 may be connected to the input end of the input coupler 6 on the right side on the page, and the waveguide 15 may be connected to the input end of the input coupler 10 on the right side on the page. The waveguide 14 and the waveguide are preferably connected to the two input ends of the input couplers 6 and 10 on the same side. The reason is that the same balanced receivers 51 and 52 having the same photodetector pair are allowed to be used for the two outputs (output ports Pout1 and Pout2) of the first MZI 4 and the two outputs (output ports Pout3 and Pout4) of the second MZI 5.

Also, as described above, the two output ends (a through port and a cross port) of the output coupler 7 of the first MZI 4 are connected to the optical output waveguides 21 and 22, respectively. Similarly, the two output ends (a through port and a cross port) of the output coupler 11 of the second MZI 5 are connected to the optical output waveguides 23 and 24, respectively.

Furthermore, in the first MZI 4, there is an optical path length difference for causing the phase of a DQPSK signal that is propagated through the first arm waveguide 8 with a long length to be delayed by the amount of delay equivalent to one bit of the symbol rate (one-bit time slot: one time slot) compared with the phase of a DQPSK signal that is propagated through the second arm waveguide 9 with a short length. For example, in the case the symbol rate is 40 Gbps, the symbol rates of the I channel and the Q channel may be 20 Gbps, which is half the above symbol rate, and the amount of delay is 50 ps (picosecond). Similarly, in the second MZI 5, there is an optical path length difference for causing the phase of a DQPSK signal that is propagated through the first arm waveguide 12 with a long length to be delayed by the amount of delay equivalent to one bit of the symbol rate (for example, in the case the symbol rate is 40 Gbps, the amount of delay of 50 ps) compared with the phase of a DQPSK signal that is propagated through the second arm waveguide 13 with a short length. Additionally, the amount of delay is not restricted to the amount that is precisely equivalent to one bit. For example, depending on the system configuration, each bit may be set to interfere with an adjacent bit with the amount of delay of approximately one bit but with a small shift from one bit.

Also, according to the interference characteristics of the two MZI 4 and 5, the phases are shifted by 90 degrees. Accordingly, the optical path length difference of the first and second arm waveguides 8 and 9 of the first MZI 4 is set to the amount of delay equivalent to one bit, with a length longer by the length corresponding to ¼π in the phase of an optical signal. On the other hand, the optical path length difference of the first and second arm waveguides 12 and 13 of the second MZI 5 is set to the amount of delay equivalent to one bit, with a length shorter by the length corresponding to ¼π in the phase of an optical signal.

The phase of interfering light of an adjacent time slot of the first MZI 4 and the phase of interfering light of an adjacent time slot of the second MZI 5 are thereby shifted by 90 degrees.

Now, the first feature of the delay demodulation device 101 according to the present first embodiment lies in the following configuration.

That is, the input couplers 6 and 10, and the output couplers 7 and 11 are each configured from a two-input two-output, 50 percent wavelength-insensitive coupler (WINC; see JP 2653883 B1, for example), and the positions of the input coupler 6 and the output coupler 7 of the first MZI 4 are in a predetermined relationship, and the positions of the input coupler 10 and the output coupler 11 of the second MZI 5 are in a predetermined relationship.

Hereinafter, the configuration of a WINC will be described taking the input coupler 6 as an example, but input coupler 10, and the output couplers 7 and 11 may also be configured in the same manner as the input coupler 6.

FIG. 3 is a schematic view illustrating the configuration of the input coupler 6. As illustrated in FIG. 3, the input coupler 6 is configured from a first waveguide 6D1 and a second waveguide 6D2. The first waveguide 6D1 includes optical input/output units 6a and 6c. The second waveguide 6D2 includes optical input/output units 6b and 6d.

The first waveguide 6D1 and the second waveguide 6D2 are arranged to be parallel to each other at two positions in the longitudinal direction, at a distance close enough that evanescent coupling occurs between the two waveguides. A first directional coupler 6DC1 and a second directional coupler 6DC2 are thereby formed, and an MZI is configured. The coupling ratio of the first directional coupler 6DC1 is set to approximately 50%. The coupling ratio of the second directional coupler 6DC2 is set to approximately 100%.

Also, the first waveguide 6D1 is longer than the second waveguide 6D2 by a waveguide length ΔL at a region between the first directional coupler 6DC1 and the second directional coupler 6DC2 (an arm portion or a ΔL portion).

With the input coupler 6, the wavelength dependence of the coupling ratio of the first directional coupler 6DC1 is eliminated by the wavelength dependence of the coupling ratio of the second directional coupler 6DC2 and by optical phase control based on setting of a waveguide length difference ΔL between the first waveguide 6D1 and the second waveguide 6D2. In this manner, the wavelength dependence of the coupling ratio of the input coupler 6 is mitigated compared with a regular directional coupler by the configuration of the WINO.

Furthermore, the waveguide widths of the first waveguide 6D1 and the second waveguide 6D2 are made narrower than other parts (for example, the ΔL portion) at parts where optical coupling of the first directional coupler 6DC1 and the second directional coupler 6DC2 occurs. The waveguide widths of the first waveguide 6D1 and the second waveguide 6D2 become gradually wider at curved waveguide parts adjacent to the first directional coupler 6DC1 and the second directional coupler 6DC2 toward the optical input/output units 6a, 6b, 6c and 6d, and the first waveguide 6D1 and the second waveguide 6D2 connect smoothly to the optical input/output units 6a, 6b, 6c and 6d.

By making the waveguide widths narrower at positions where optical coupling of the first directional coupler 6DC1 and the second directional coupler 6DC2 occurs, the coupling between the waveguides becomes stronger, and thus, the length of the coupling unit for obtaining a desired coupling ratio is able to be shortened. The length of the input coupler 6 is thereby shortened, and miniaturization is able to be achieved.

Circuit parameters of the input coupler 6 are as shown in Table 1 below, for example. Additionally, a DC coupling unit is a part where optical coupling of a directional coupler occurs. Also, the height of a waveguide is 6 μm. Furthermore, the relative refractive-index difference Δ of a waveguide (a core) with respect to a clad of the waveguide is 1.2%.

TABLE 1

| | |
|---|---|
| Item | Value |

| | | |
|---|---|---|
| Waveguide width | Input/output unit | 6 μm |
| | ΔL portion | 6 μm |
| | DC coupling unit | 2.5 μm |
| Length of DC coupling unit | DC1 | 150 μm |
| | DC2 | 400 μm |
| DC coupling ratio | DC1 | About 50% |
| | DC2 | About 100% |

| | |
|---|---|
| Waveguide length difference ΔL | 0.37 μm |

Here, the wavelength dependence of a coupling ratio κ will be described with respect to the input coupler 6 whose circuit parameters are set according to Table 1 and a regular 50 percent directional coupler the size of whose waveguide is 6 μm×6 μm and whose relative refractive-index difference Δ is 1.2%.

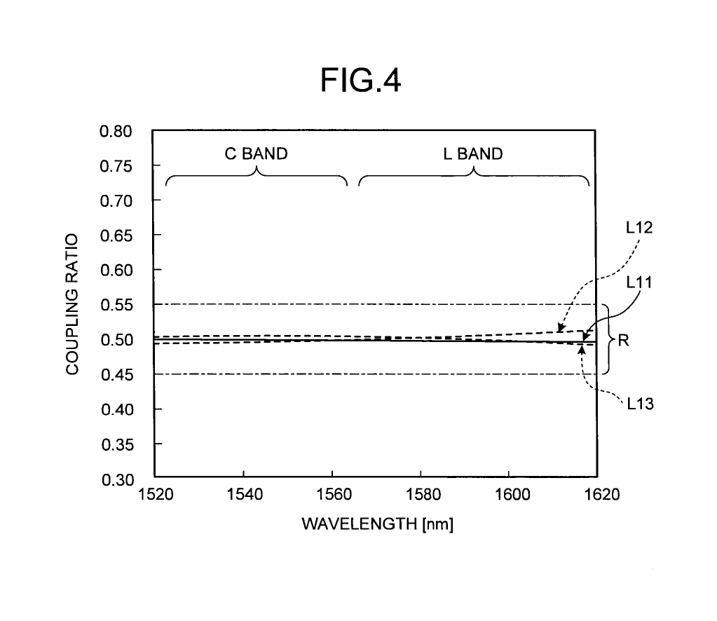

FIG. 4 is a diagram illustrating a calculated value of the wavelength dependence of the coupling ratio κ of the input coupler 6. In FIG. 4, a range R is a range where the coupling ratio is 50% plus or minus 5%. A line L11 shows characteristics of a case where the circuit parameters of the input coupler 6 are values as designed. A line L12 shows characteristics of a case where the distance between the waveguides at the DC coupling unit is shifted by 0.05 μm than the designed value so as to be narrower. A line L13 shows characteristics of a case where the distance between the waveguides at the DC coupling unit is shifted by 0.05 μm than the designed value so as to be wider.

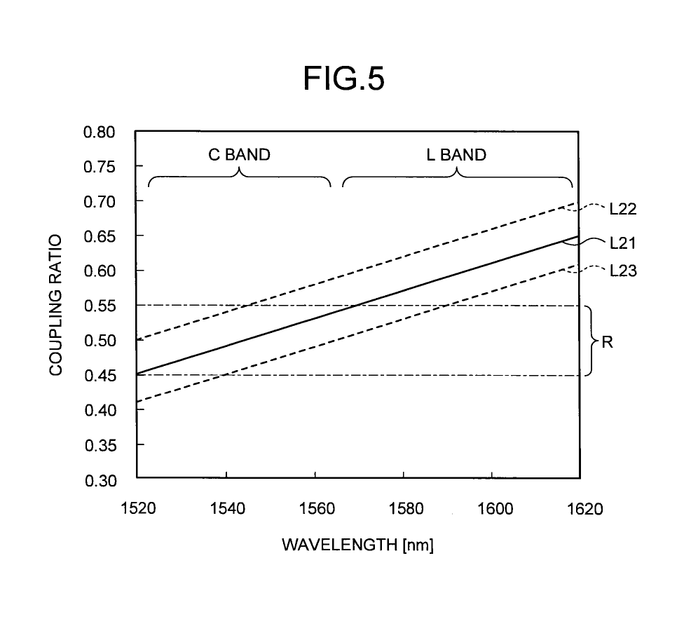

FIG. 5 is a diagram illustrating a calculated value of the wavelength dependence of the coupling ratio κ of a regular 50 percent directional coupler. In FIG. 5, a range R is a range where the coupling ratio is 50% plus or minus 5%. A line L21 shows characteristics of a case where the circuit parameters of the 50 percent directional coupler are values as designed. A line L22 shows characteristics of a case where the distance between the waveguides at the DC coupling unit is shifted by 0.05 μm than the designed value so as to be narrower. A line L23 shows characteristics of a case where the distance between the waveguides at the DC coupling unit is shifted by 0.05 than the designed value so as to be wider.

As illustrated in FIGS. 4 and 5, with respect to the coupling ratio of the regular 50 percent directional coupler, the wavelength characteristics are approximately plus or minus 4% in a C band and approximately plus or minus 10% when also taking an L band into account, and in addition, a variation of approximately 4% is caused with respect to a small manufacturing variance of plus or minus 0.05 μm for the distance between the waveguides of the DC coupling unit. In contrast, with the input coupler 6 which is a WINC, the coupling ratio is approximately 50% throughout the whole range of a CL band (approximately 1520 to 1620 nm) even with a manufacturing variance, and the wavelength characteristics are fairly flat compared to that of the regular 50 percent directional coupler. That is, the wavelength dependence of the coupling ratio is greatly reduced.

It is conceivable from the result above that the extinction ratio of the delay demodulation device 101 will be made high throughout a wide wavelength bandwidth by having WINCs as the input couplers 6 and 10 and the output couplers 7 and 11.

However, when the present inventors actually manufactured delay demodulation devices with the configuration of FIG. 1 and carefully examined the characteristics, the inventors discovered that the wavelength dependence of the extinction ratio of the delay demodulation devices were different depending on the arrangement of the input coupler and the output coupler forming the MZI. A concrete explanation will be given below.

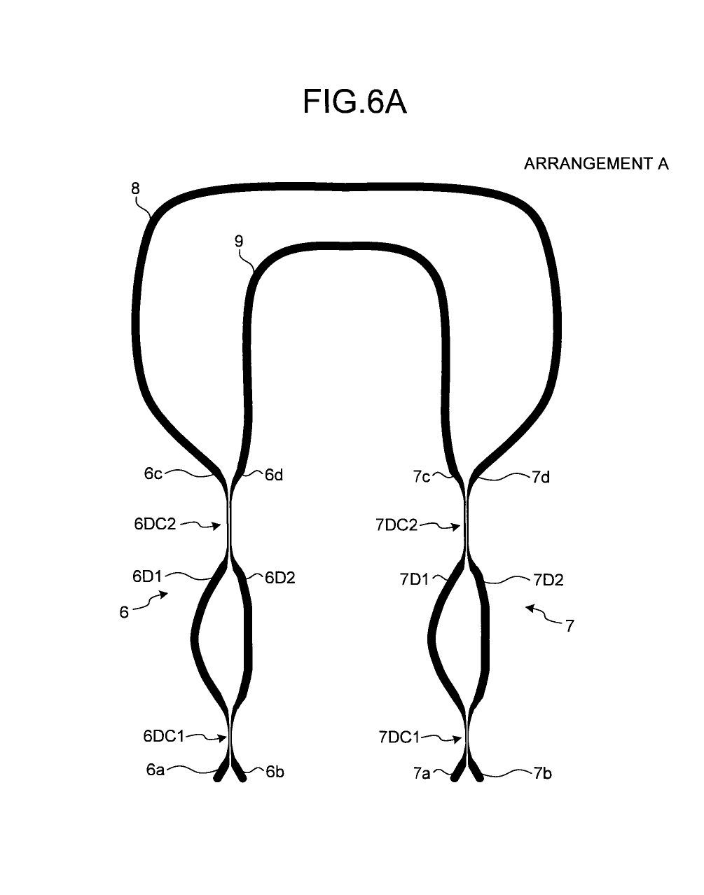

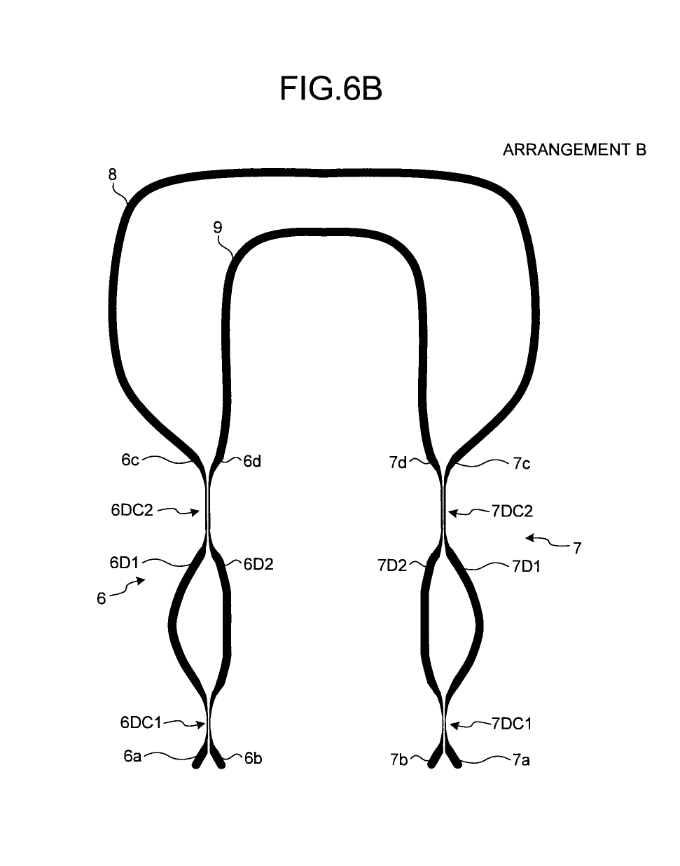

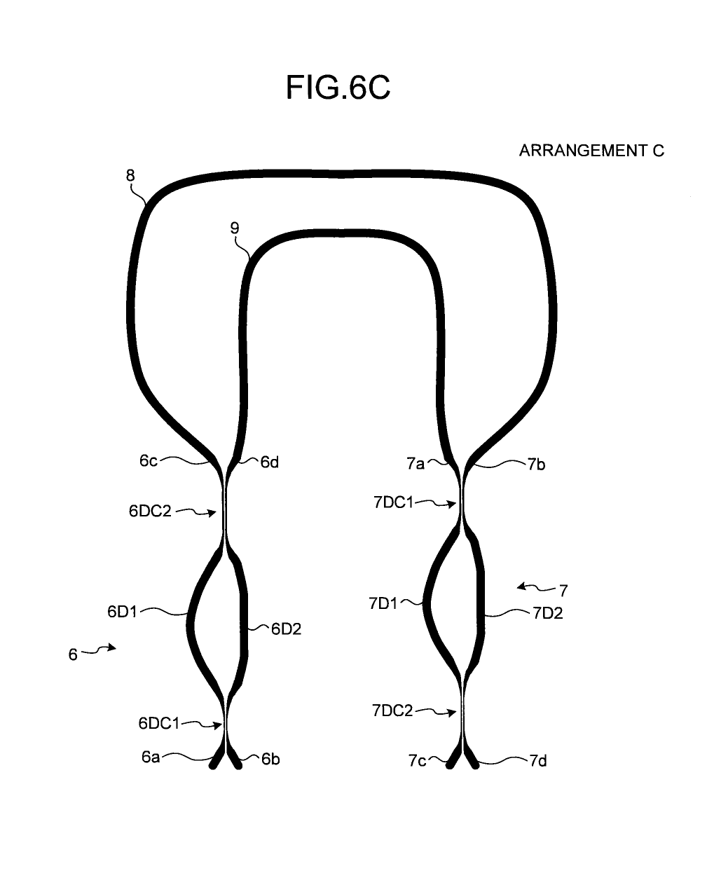

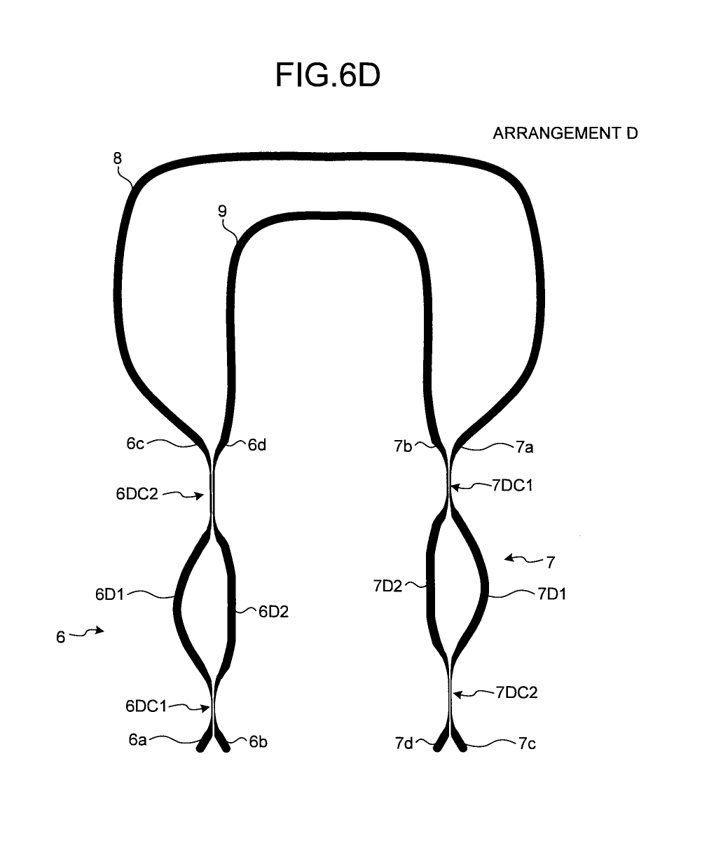

FIGS. 6A to 6D are views illustrating examples of an arrangement relationship between the input coupler 6 and the output coupler 7 with respect to the first MZI 4. Additionally, in FIGS. 6A to 6D, the forms of the first arm waveguide 8 and the second arm waveguide 9 are illustrated in a simplified manner for the sake of explanation. Also, in FIGS. 6A to 6D, the first MZI 4 is illustrated for the explanation, but the arrangement relationship between the input coupler 10 and the output coupler 11 of the second MZI 5 can be described in the same manner.

As with the first MZI 4 illustrated in FIG. 1, according to the arrangement of FIG. 6A (hereinafter, the arrangement A) for the input coupler 6, the first directional coupler 6DC1 is arranged on the input side of an optical signal, and the second directional coupler 6DC2 is arranged on the side of the first and second arm waveguides 8 and 9. Also, the first waveguide 6D1 with a long waveguide length is arranged on the left side on the page with respect to the longitudinal direction of the input coupler 6. Furthermore, with respect to the output coupler 7, optical input/output units 7a and 7b, and a first directional coupler 7DC1 whose coupling ratio is 50% are arranged. Furthermore, optical input/output units 7c and 7d, and a second directional coupler 7DC2 whose coupling ratio is 100% are arranged on the side of the first and second arm waveguides 8 and 9. Still further, a first waveguide 7D1 with a wavelength longer than that of a second waveguide 7D2 is arranged on the left side on the page with respect to the longitudinal direction of the output coupler 7. That is, in this arrangement A, the side on which the first waveguide 6D1 is arranged with respect to the longitudinal direction of the input coupler 6 and the side on which the first waveguide 7D1 is arranged with respect to the longitudinal direction of the output coupler 7 are the same. The input coupler 6 and the output coupler 7 are arranged such that if either is parallel-translated on the page (on the surface where the planar lightwave circuit 1A is formed), they will coincide with each other.

The arrangement of FIG. 6B (hereinafter, the arrangement B) is the same as the arrangement A with respect to the input coupler 6, and the first waveguide 6D1 with a long waveguide length is arranged on the left side on the page with respect to the longitudinal direction of the input coupler 6. On the other hand, with respect to the output coupler 7, the first directional coupler 7DC1 is arranged on the output side of an optical signal, and a second directional coupler 7DC2 is arranged on the side of the first and second arm waveguides 8 and 9. Also, the first waveguide 7D1 with a waveguide length longer than that of the second waveguide 7D2 is arranged on the right side on the page with respect to the longitudinal direction of the output coupler 7. That is, in this arrangement B, the side on which the first waveguide 6D1 is arranged with respect to the longitudinal direction of the input coupler 6 and the side on which the first waveguide 7D1 is arranged with respect to the longitudinal direction of the output coupler 7 are opposite each other. The input coupler 6 and the output coupler 7 are arranged such that if either is line-symmetrically moved with respect to a line drawn on the page, between the input coupler 6 and the output coupler 7, along the longitudinal direction, they will coincide with each other.

The arrangement of FIG. 6C (hereinafter, the arrangement C) is the same as the arrangement A with respect to the input coupler 6, and the first waveguide 6D1 with a long waveguide length is arranged on the left side on the page with respect to the longitudinal direction of the input coupler 6. On the other hand, with respect to the output coupler 7, the second directional coupler 7DC2 is arranged on the output side of an optical signal, and the first directional coupler 7DC1 is arranged on the side of the first and second arm waveguides 8 and 9. Also, the first waveguide 7D1 with a waveguide length longer than that of the second waveguide 7D2 is arranged on the left side on the page with respect to the longitudinal direction of the output coupler 7. That is, in this arrangement C, the side on which the first waveguide 6D1 is arranged with respect to the longitudinal direction of the input coupler 6 and the side on which the first waveguide 7D1 is arranged with respect to the longitudinal direction of the output coupler 7 are the same. The input coupler 6 and the output coupler 7 are arranged such that if either is line-symmetrically moved with respect to a line drawn on the page, between the input coupler 6 and the output coupler 7, along the longitudinal direction, and then is rotated 180 degrees, they will coincide with each other.

The arrangement of FIG. 6D (hereinafter, the arrangement D) is the same as the arrangement A with respect to the input coupler 6, and the first waveguide 6D1 with a long waveguide length is arranged on the left side on the page with respect to the longitudinal direction of the input coupler 6. On the other hand, with respect to the output coupler 7, the second directional coupler 7DC2 is arranged on the output side, and the first directional coupler 7DC1 is arranged on the side of the first and second arm waveguides 8 and 9. Also, the first waveguide 7D1 with a waveguide length longer than that of the second waveguide 7D2 is arranged on the right side on the page with respect to the output coupler 7. That is, in this arrangement D, the side on which the first waveguide 6D1 is arranged with respect to the longitudinal direction of the input coupler 6 and the side on which the first waveguide 7D1 is arranged with respect to the longitudinal direction of the output coupler 7 are opposite each other. The input coupler 6 and the output coupler 7 are arranged such that if either is rotated 180 degrees on the page and is parallel-translated, they will coincide with each other.

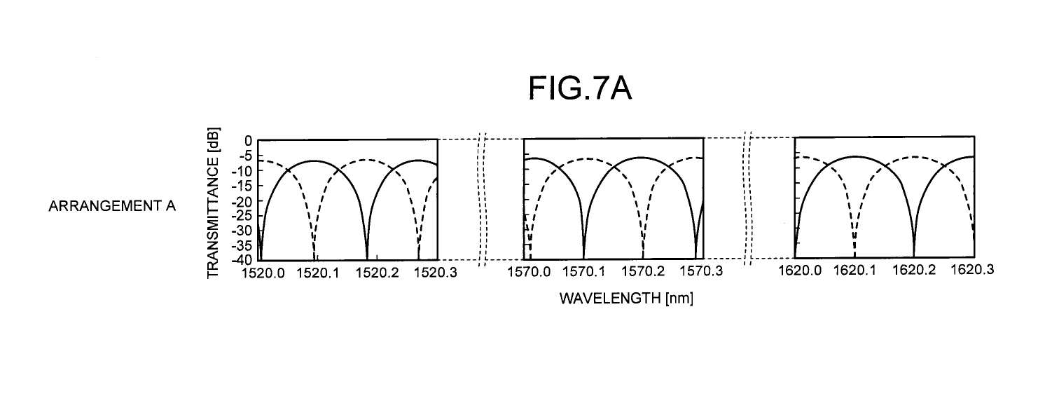

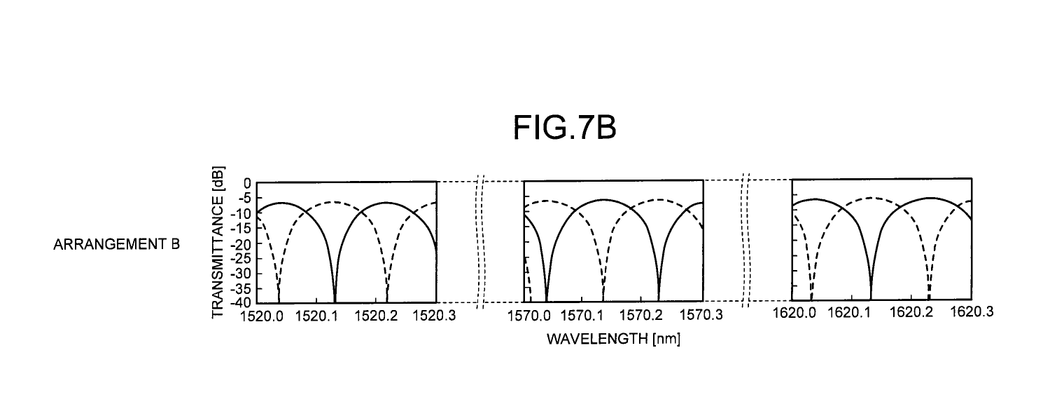

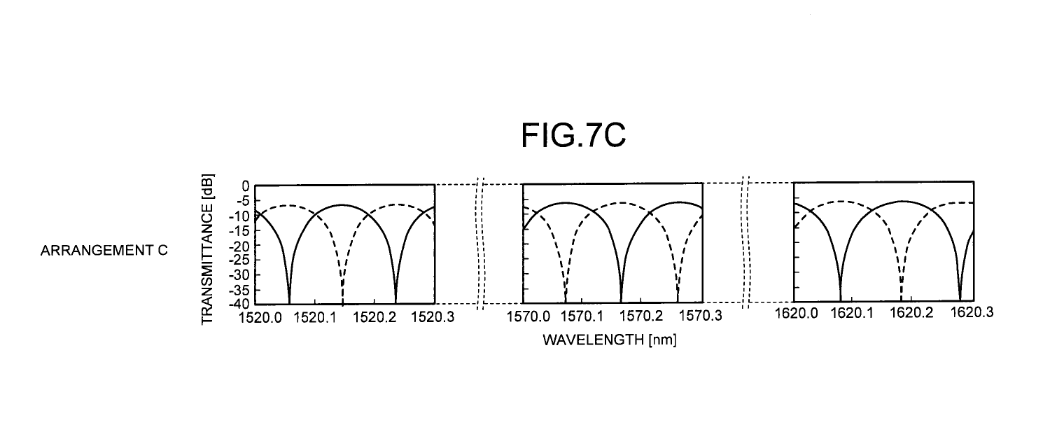

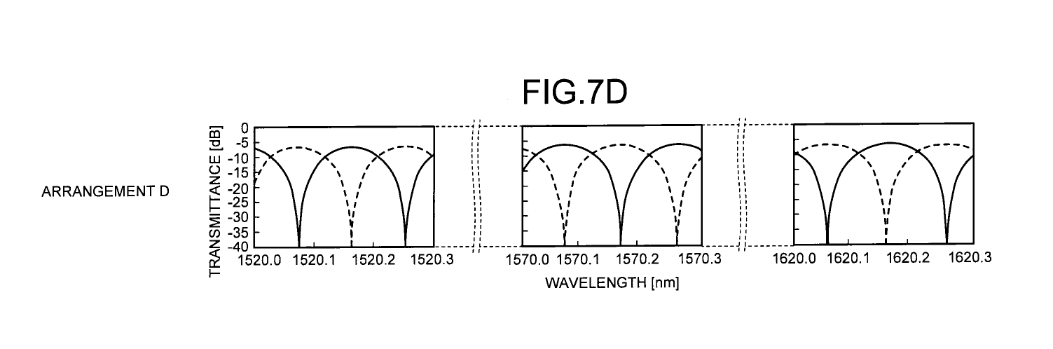

FIG. 7A is a diagram illustrating a calculated value of a transmission spectrum of the first MZI where the arrangement A is assumed. FIG. 7B is a diagram illustrating a calculated value of a transmission spectrum of the first MZI where the arrangement B is assumed. FIG. 7C is a diagram illustrating a calculated value of a transmission spectrum of the first MZI where the arrangement C is assumed. FIG. 7D is a diagram illustrating a calculated value of a transmission spectrum of the first MZI where the arrangement D is assumed. As illustrated in FIGS. 7A to 7D, when the arrangement is changed, the transmission peak and the free spectral range (FSR) subtly change. However, the degree of this change is such that when these are used in relation to a delay demodulation device, all the arrangements can be said to have approximately the same characteristics.

However, in the actual manufacturing, a manufacturing variation occurs in the characteristics of the input and output couplers which are 50 percent WINCs. Particularly, it is difficult to precisely create an infinitesimal waveguide length difference ΔL of approximately 1 μm or less (or a corresponding infinitesimal phase difference of 2π or less), and the characteristics will change because of the positions or the directions of arrangement of the input and output couplers on the wafer surface used for manufacturing a PLC chip.

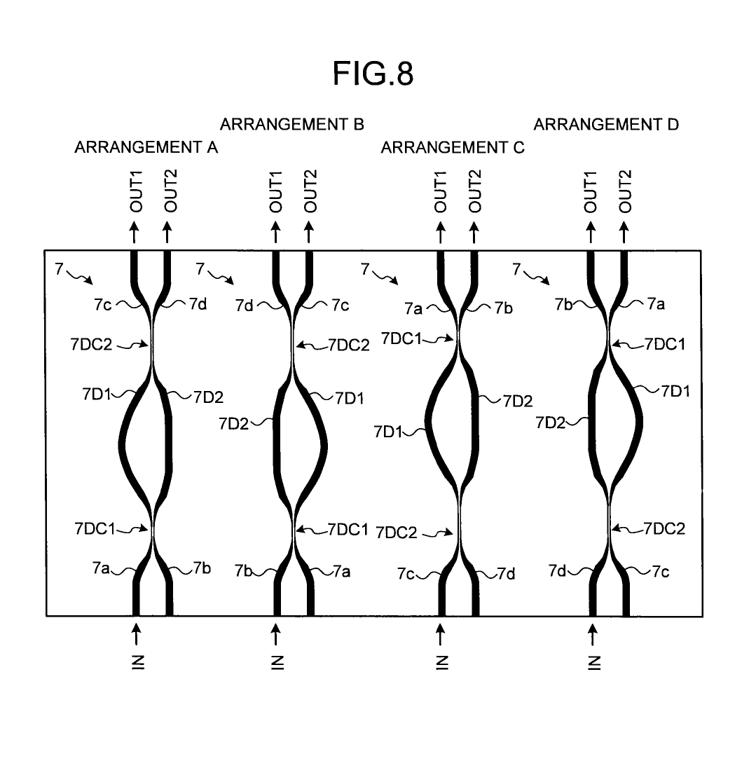

Accordingly, the present inventors fabricated, arranging next to each other, couplers whose arrangements were changed as with the output couplers 7 illustrated in FIGS. 6A to 6D. FIG. 8 is a view illustrating the arrangements of fabricated output couplers 7. Additionally, the circuit parameters of the output couplers 7 were all according to the values of Table 1. Moreover, each output coupler 7 was arranged in such a way that, at the time of fabrication, the top side of the page in FIG. 8 was the orientation flat direction of the silicon wafer.

Furthermore, light was input to each of the fabricated output couplers 7 from “IN” in FIG. 8 and the outputs of light from “OUT1” and “OUT2” were measured to thereby obtain the coupling ratio κ.

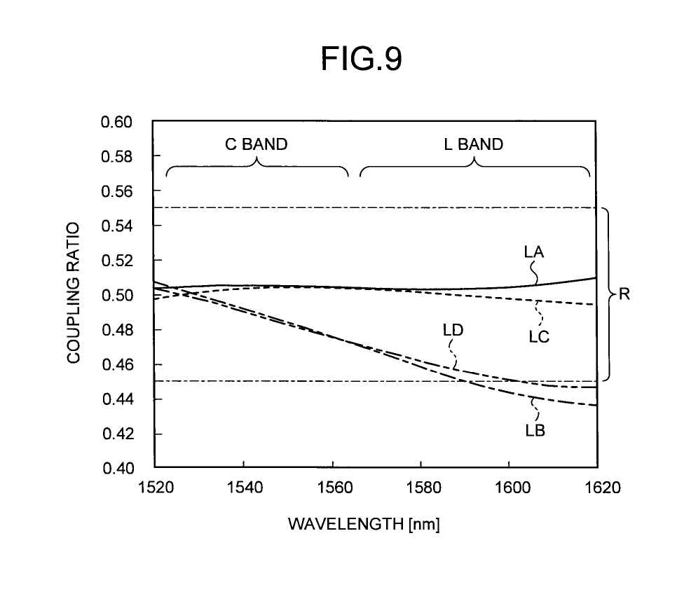

FIG. 9 is a diagram illustrating a measured value of wavelength dependence of the coupling ratio κ of the fabricated output coupler of each arrangement.

Additionally, lines LA, LB, LC and LD each show the characteristics of the output coupler 7 of the arrangement A, B, C or D. As illustrated in FIG. 9, in the arrangements A and C, flat wavelength characteristics where the coupling ratios K are 50% plus or minus 2% indicated by a range R were obtained in a wavelength bandwidth from 1520 to 1620 nm. However, in the arrangements B and D, the wavelength characteristics were inclined and the coupling ratios κ exceeded 50% plus or minus 5% in a wavelength bandwidth from 1520 to 1620 nm, and there was a band where deterioration of the extinction ratio to below 20 dB was expected if applied to the MZI.

Regarding the wavelength characteristics of the arrangements A and C, it can be assumed that the coupling ratio of the directional coupler varied within approximately 5%, as illustrated in FIG. 4. However, regarding the wavelength characteristics of the arrangements B and D, the change in the coupling ratio of the directional coupler is not a sufficient explanation, and it is considered that the manufacture error in the phase difference between waveguides occurring in the process of patterning or embedding in the clad of the waveguides in the waveguide fabrication process is the cause, and also, that there is directionality in that manufacture error.

Accordingly, it may seem possible to correct the designed value of the waveguide length difference ΔL such that preferable characteristics are obtained by the orientations of the arrangements B and D, but this will result in the deterioration in the characteristics with respect to the orientations of the arrangements A and C. Also, it is conceivable to adopt different circuit parameters for the input coupler and the output coupler that are the 50 percent WINCs, but if the orientation is different, the tendency of the manufacturing variance is different, and thus, there is a possible deterioration in the characteristics for what is actually manufactured.

According to the result of the close examination described above conducted by the present inventors, by causing the side on which the first waveguide 6D1 is arranged with respect to the longitudinal direction of the input coupler 6 and the side on which the first waveguide 7D1 is arranged with respect to the longitudinal direction of the output coupler 7 to be the same in the first MZI 4, as illustrated in FIG. 1 or 6A, the coupling ratios of the input coupler 6 and the output coupler 7 are able to be made approximately the same and approximately 50% over a wide wavelength bandwidth. Additionally, similarly, with the second MZI 5, by causing the side on which the first waveguide is arranged with respect to the longitudinal direction of the input coupler 10 and the side on which the first waveguide is arranged with respect to the longitudinal direction of the output coupler 11 to be the same, the coupling ratios of the input coupler 10 and the output coupler 11 are able to be made approximately the same and approximately 50% over a wide wavelength bandwidth.

Next, the second feature of the delay demodulation device 101 according to the present first embodiment lies in the following configuration.

That is, a tap coupler 80 is configured from a two-input two-output, 5 percent wavelength-insensitive coupler (a 5 percent WINO).

The tap coupler 80 is configured from a third waveguide and a fourth waveguide. The third waveguide and the fourth waveguide are arranged to be parallel to each other at two positions in the longitudinal direction, at a distance close enough that evanescent coupling occurs between the two waveguides. A third directional coupler whose coupling ratio is approximately 5% and a fourth directional coupler whose coupling ratio is approximately 10% are thereby formed, and an MZI is configured. Also, the waveguide length (the optical path length) of the third waveguide is longer than that of the fourth waveguide by approximately 0.65 μm at a region between the third and fourth directional couplers (an arm portion or a ΔL portion).

With the configuration of the WINC described above, the wavelength dependence of the coupling ratio of the tap coupler 80 is reduced compared with a regular directional coupler. Thus, the monitor accuracy for the input optical power of a DQPSK is increased.

Furthermore, the waveguide widths of the third waveguide and the fourth waveguide become narrow at parts where the optical coupling of third and fourth directional couplers occurs. The waveguide widths of the third waveguide and the fourth waveguide become gradually wider at curved waveguide parts adjacent to the third and fourth directional couplers toward optical input/output units, and the third waveguide and the fourth waveguide connect smoothly to the optical input/output units.

By making the waveguide widths narrower at positions where optical coupling of the third and fourth directional couplers occurs, the coupling between the waveguides becomes stronger, and thus, the length of the coupling unit for obtaining a desired coupling ratio is able to be shortened. The length of the tap coupler 80 is thereby shortened, and miniaturization is able to be achieved.

Circuit parameters of the tap coupler 80 are as shown in Table 2 below, for example. Additionally, the height of a waveguide is 6 μm. Furthermore, the relative refractive-index difference Δ of a waveguide (a core) with respect to a clad of the waveguide is 1.2%, for example.

TABLE 2

| | |
|---|---|
| Item | Value |

| | | |
|---|---|---|
| Waveguide width | Input/output unit | 6 μm |
| | ΔL portion | 6 μm |
| | DC coupling unit | 4 μm |
| Length of DC coupling unit | DC1 | 45 μm |
| | DC2 | 130 μm |
| DC coupling ratio | DC1 | About 5% |
| | DC2 | About 10% |

| | |
|---|---|
| Waveguide length difference ΔL | 0.65 μm |

The third feature of the delay demodulation device 101 according to the present first embodiment lies in the following configuration.

That is, the delay demodulation device 101 includes a first ½ wavelength plate 47 at middle portions of the first and second arm waveguides 8 and 9 of the first MZI 4 and the first and second arm waveguides 12 and 13 of the second MZI 5, installed in such a way as to cross all of the four arm waveguides 8, 9, 12 and 13, and the four arm waveguides 8, 9, 12 and 13 come close to one another at the part where the first ½ wavelength plate 47 is provided.

Furthermore, the delay demodulation device 101 includes a second ½ wavelength plate 70 installed for the first and second arm waveguides 8 and 9 of the first MZI 4 and the first and second arm waveguides 12 and 13 of the second MZI 5 in such a way as to cross all of the four arm waveguides 8, 9, 12 and 13, and the four arm waveguides 8, 9, 12 and 13 come close to one another at the part where the second ½ wavelength plate 70 is provided.

As described, the four arm waveguides 8, 9, 12 and 13 come close to one another at the parts where the first ½ wavelength plate 47 and the second ½ wavelength plate 70 are provided, and thus, the delay demodulation device 101 is miniaturized.

The fourth feature of the delay demodulation device 101 lies in the following configuration.

That is, the arm waveguides of the MZIs 4 and 5 are arranged in the planar lightwave circuit 1A in such a way as to overlap one another in the same region. Specifically, the second arm waveguide 9 of the first MZI 4 and the first arm waveguide 12 of the second MZI 5 are formed in the planar lightwave circuit 1A so as to overlap each other in a region surrounded by the first MZI 4 which is the outermost part.

Furthermore, the waveguide arrangement at the part where the first and second wavelength plates 47 and 70 are provided is, from the outside, the first arm waveguide 8 of the first MZI 4, the first arm waveguide 12 of the second MZI 5, the second arm waveguide 9 of the first MZI 4, and the second arm waveguide 13 of the second MZI 5. That is, the first arm waveguide 12 of the second MZI 5 is arranged between the first and second arm waveguides 8 and 9 of the first MZI 4. Also, the second arm waveguide 9 of the first MZI 4 and the first arm waveguide 12 of the second MZI 5 cross each other at the two crossing points 62 and 64 on the both sides of the first and second wavelength plates 47 and 70. The crossing angle is 63 degrees, for example.

With this configuration, the distance between the waveguides at the parts where the first and second wavelength plates 47 and 70 are provided is able to be shortened with the minimum number of crossings.

Additionally, as described above, the second arm waveguide 9 of the first MZI 4 and the first arm waveguide 12 of the second MZI 5 cross each other at each of the crossing points 62 and 64, but the light (a DQPSK signal) propagated through each arm waveguide will be propagated through the same arm waveguide after passing through each crossing point 62 or 64. For example, a DQPSK signal which is propagated through the first arm waveguide 9 will propagate through the same first arm waveguide 9 after passing through the crossing point 62.

The fifth feature of the delay demodulation device 101 lies in the following configuration.

That is, an optical path length 11 of the second arm waveguide 9, which is the shorter arm waveguide of the first MZI 4, and an optical path length 12 of the second arm waveguide 13, which is the shorter arm waveguide of the second MZI 5, are different from each other, and optical path lengths 121 and 122 from the Y-branch waveguide 3 to the output side (the output ports Pout1 and Pout2 of the optical output waveguides 21 and 22) of the first MZI 4 via the second arm waveguide 9 of the first MZI 4 and optical path lengths 123 and 124 from the Y-branch waveguide 3 to the output side (the output ports Pout3 and Pout4 of the optical output waveguides 21 and 22) of the second MZI 5 via the second arm waveguide 13 of the second MZI 5 are made approximately the same.

Specifically, each of the optical path lengths of the four paths of the optical signal from the Y-branch waveguide 3 to the four output ends (the output ports Pout1 to Pout4) is as follows.

The optical path length from the Y-branch waveguide 3 to the output port Pout1 via the waveguide 14, the input coupler 6, the second arm waveguide 9 and the output coupler 7 of the first MZI 4, and the optical output waveguide 21 is 121.

The optical path length from the Y-branch waveguide 3 to the output port Pout2 via the waveguide 14, the input coupler 6, the second arm waveguide 9 and the output coupler 7 of the first MZI 4, and the optical output waveguide 22 is 122.

The optical path length from the Y-branch waveguide 3 to the output port Pout3 via the waveguide 15, the input coupler 10, the second arm waveguide 13 and the output coupler 11 of the second MZI 5, and the optical output waveguide 23 is 123.

Furthermore, the optical path length from the Y-branch waveguide 3 to the output port Pout4 via the waveguide 15, the input coupler 10, the second arm waveguide 13 and the output coupler 11 of the second MZI 5, and the optical output waveguide 24 is 124.

In other words, the fifth feature described above lies in that the optical path length 11 of the second arm waveguide 9, which is the shorter arm waveguide of the first MZI 4, and the optical path length 12 of the second arm waveguide 13, which is the shorter arm waveguide of the second MZI 5, are different from each other, and that the four optical path lengths 121 to 124 described above are all the same.

In the present first embodiment, to realize the fifth feature described above, the optical path length 11 of the second arm waveguide 9 is made longer than the optical path length 12 of the first arm waveguide 13, the optical path lengths of the optical output waveguides 21 to 24 are made all the same, and the waveguide 15 is formed to be longer than the waveguide 14 by (11-12).

At this time, the lengths of the waveguides 14 and 15 are enabled to be easily adjusted in a narrow region by forming each of the waveguide 15 and the waveguide 14 into a U-shape including a curved waveguide and arranging the waveguide 15 in such a way that it goes around the outer side of the waveguide 14.

Now, the U-shaped waveguides 14 and 15 will be concretely described.

An input end of the optical input waveguide 2 is provided on an edge surface 1b forming one of the long sides of the PLC chip 1B (the upper long side on the page) which is rectangular in a planar view. This optical input waveguide 2 extends from the input port, straight along, and near, the edge surface forming the short side on the left of the PLC chip 1B, and is connected to an input end of the Y-branch waveguide 3. The waveguide 14 connected to one output end of the Y-branch waveguide 3 is a U-shaped waveguide formed from a curved waveguide whose curve angle is approximately 180 degrees, and connects the Y-branch waveguide 3 and the input coupler 6.

On the other hand, the waveguide 15 connected to the other output end of the Y-branch waveguide 3 is a U-shaped waveguide that is arranged so as to go around the outer side of the waveguide 14, that is, on the side near an edge surface 1a opposite the edge surface 1b. This U-shaped waveguide 15 is formed from a curved waveguide whose curving angle is approximately 90 degrees, a straight waveguide and a curved waveguide whose curving angle is approximately 90 degrees, and connects the Y-branch waveguide 3 and the input coupler 10.

By forming the waveguide 15 and the waveguide 14 into U-shaped waveguides as described above, the lengths are able to be easily adjusted in a narrow region.

Additionally, in the present first embodiment illustrated in FIG. 1, the waveguide 15 is arranged so as to go around the outer side of the waveguide 14, but the present invention is not limited to such a configuration. For example, depending on the value of the difference of length between the waveguides 14 and 15, a configuration is possible according to which the waveguide 14, at first, goes around the outer side of the waveguide 15 after being branched at the Y-branch waveguide 3, and then, the waveguide 14 and the waveguide 15 cross each other, and the waveguides 14 and 15 connect to the input couplers 6 and 10, respectively.

Additionally, the delay demodulation device 101 may be fabricated in the following manner.

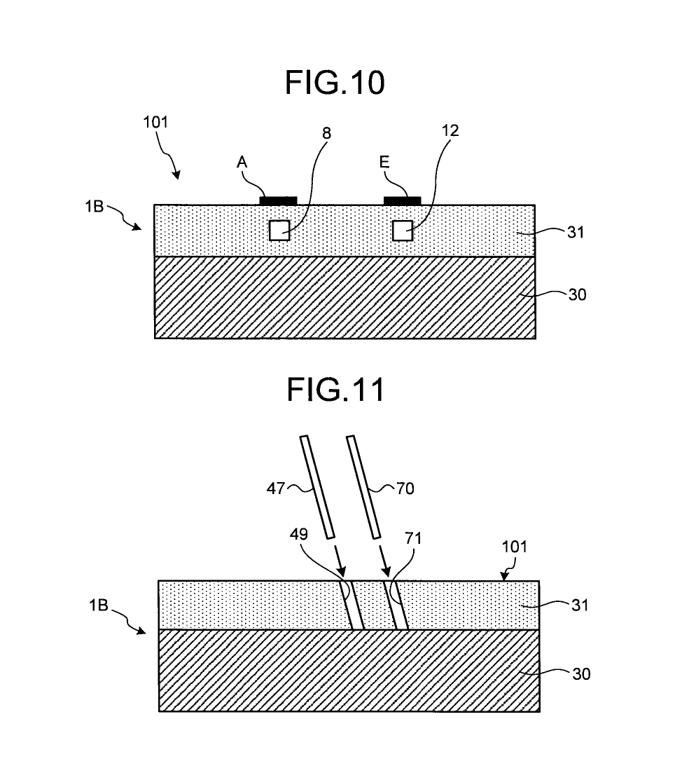

FIG. 10 is a cross-sectional view along line X-X in FIG. 1. First, silica materials (SiO₂ series glass particles) to be a lower cladding layer and a core layer are sequentially accumulated on a wafer formed of silicon or the like by a flame hydrolysis deposition (FHD) method, and the accumulated layers are melted and made transparent by heating. Next, the core layer is formed into a desired waveguide pattern using photolithography and reactive ion etching. Then, an upper cladding layer is formed by the FHD method so as to cover the upper and lateral portions of the waveguide pattern. A heater or the like described later is then formed and element isolation is performed to thereby manufacture the delay demodulation device 101, as illustrated in FIG. 10, that includes, on a PLC substrate 30 which is a part of the wafer, a cladding layer 31 formed from the lower cladding layer and the upper cladding layer, the arm waveguides 8 and 12 as the core portions formed inside the cladding layer 31, and heaters A and E. Additionally, as illustrated in FIG. 1, the PLC substrate 30 has a rectangular planar shape, but it may be of a square shape or another shape.

Another feature of the delay demodulation device 101 lies in the following configuration.

That is, with this delay demodulation device 101, a first ½ wavelength plate 47 whose principal axis is tilted by 45 degrees with respect to the refractive index principal axis of each arm waveguide is inserted at the middle portions of the first and second arm waveguides 8 and 9 of the first MZI 4 and the middle portions of the first and second arm waveguides 12 and 13 of the second MZI 5, to thereby reduce polarization dependent frequency shift (PDF). Also, the first MZI 4 and the second MZI 5 are formed to be approximately left-right symmetrical on the PLC substrate 30 with respect to the insertion portion of the first ½ wavelength plate 47.

Furthermore, with this delay demodulation device 101, a second ½ wavelength plate 70 whose principal axis is parallel or horizontal with respect to the refractive index principal axis of each arm waveguide is inserted at a position 200 μm to the output side from the middle portions of the first and second arm waveguides 8 and 9 of the first MZI 4 and the middle portions of the first and second arm waveguides 12 and 13 of the second MZI 5.

As described in WO 2008/084707 A, by using the first and second ½ wavelength plates 47 and 70, the interference conditions of polarization converted light are made the same as the interference conditions of regular light that is not polarization-converted even if polarization conversion occurs in a coupler configuring the MZI, and thus, deterioration in the PDF is able to be suppressed. Additionally, the PDF is a phenomenon where the peak of the frequency of the transmission characteristics caused by an optical interferometer is different for two polarization states of light (a TM wave and a TE wave) propagating through an optical waveguide.

FIG. 11 is a cross-sectional view along line Y-Y in FIG. 1. As illustrated in FIG. 11, grooves 49 and 71 are formed in the cladding layer 31. The first and second ½ wavelength plates 47 and 70 are inserted into the grooves 49 and 71, respectively. The grooves 49 and 71 are grooves that are inclined by approximately eight degrees with respect to a surface vertical to the arm waveguides of the first and second MZIs 4 and 5, to the longitudinal direction of the arm waveguides. As a result, when the first and second ½ wavelength plates 47 and 70 are inserted into the grooves 49 and 71, the first and second ½ wavelength plates 47 and 70 will also be inclined by approximately eight degrees with respect to a surface vertical to the arm waveguides, and thus, light loss due to surface reflection of the first and second ½ wavelength plates 47 and 70 is suppressed.

Also, as illustrated in FIG. 1, with this delay demodulation device 101, the middle portions of the first and second arm waveguides 8 and 9 of the first MZI 4 extend in parallel to, and close to, each other, and the middle portions of the first and second arm waveguides 12 and 13 of the second MZI 5 extend in parallel to, and close to, each other.

Additionally, at the middle portions of the first and second arm waveguides 8 and 9 and the middle portions of the first and second arm waveguides 12 and 13, the waveguide widths of parts where the ½ wavelength plates 47 and 70 are to be inserted are slightly widened, and diffraction loss is thereby suppressed.

Also, the arrangement position of the second ½ wavelength plate 70 is not restricted to be near the first ½ wavelength plate 47 as illustrated in FIG. 1, but the second ½ wavelength plate 70 is desirably arranged near the first ½ wavelength plate 47 at a position where the waveguide width of each of the arm waveguides 8, 9, 12 and 13 is widened, which is where the first ½ wavelength plate 47 is arranged.

Another feature of the delay demodulation device 101 lies in the following configuration.

As illustrated in FIG. 1, the output ends of the two optical output waveguides 21 and 22 (the output ports Pout1 and Pout2) and the output ends of the two optical output waveguides 23 and 24 (the output ports Pout3 and Pout4) are open on the same edge surface 1a of the PLC chip 1B. That is, the output ports Pout1 to Pout4, which are the output ends of the four optical output waveguides 21 to 24, are open on the same edge surface 1a which is one of the four sides of the PLC chip 1B at positions near one another.

On the other hand, the input end of the optical input waveguide 2 is provided on the edge surface 1b opposite the edge surface 1a of the PLC chip 1B.

Also, with this delay demodulation device 101, heaters are formed on each of the first and second arm waveguides 8 and 9 of the first MZI 4 and the first and second arm waveguides 12 and 13 of the second MZI 5.

That is, heaters A and C are formed on the first arm waveguide 8 on both sides of its middle portion, and heaters B and D are formed on the second arm waveguide 9 on both sides of its middle portion. On the other hand, heaters E and G are formed on the first arm waveguide 12 on both sides of its middle portion, and heaters F and H are formed on the second arm waveguide 13 on both sides of its middle portion. Each of the heaters A to H are positioned above the corresponding arm waveguide, and is a Ta series, thin film heater formed by sputtering on the cladding layer 31, as illustrated in FIG. 10.

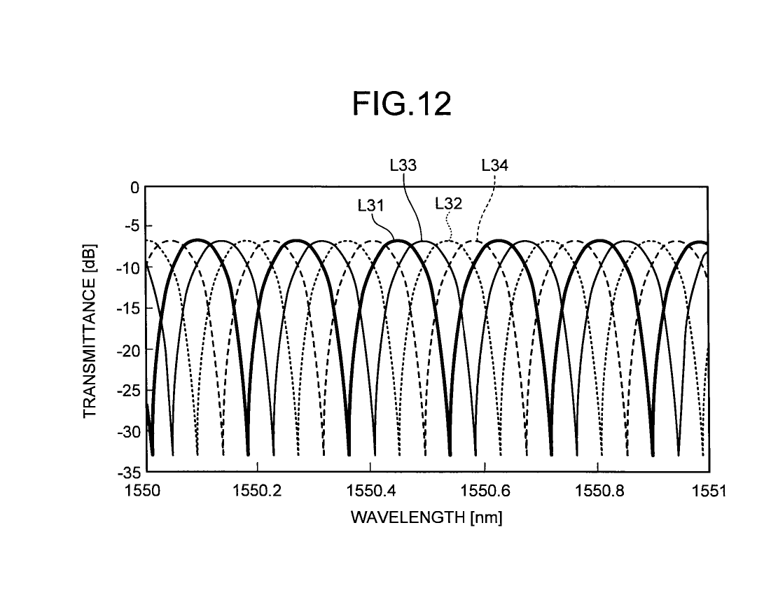

FIG. 12 is a diagram illustrating transmission characteristics of the delay demodulation device 101. According to this delay demodulation device 101, the output ends of the optical output waveguides 21 and 22 are the output ports Pout1 and Pout2 that output optical signals (intensity-converted optical signals) of outputs 1 and 2, respectively, with output characteristics according to which the phases are shifted from each other by it (lines L31 and L32 in FIG. 12). On the other hand, the output ends of the optical output waveguides 23 and 24 are the output ports Pout3 and Pout4 that output optical signals of outputs 3 and 4, respectively, with output characteristics according which the phases are shifted from each other by it (lines L33 and L34 in FIG. 12).

According to the delay demodulation device 101 having the configuration described above, in the first MZI 4, a DQPSK signal transmitted from the optical fiber transmission path 54 to the optical receiver 50 is divided by the Y-branch waveguide 3, and the DQPSK signals obtained by the dividing are propagated through the first and second arm waveguides 8 and 9 of different lengths of the first MZI 4. The first MZI 4 delays the phase of the DQPSK signal that is propagated through the first arm waveguide 8 by the amount of delay equivalent to one bit of the symbol rate+¼π compared with the phase of the optical signal that is propagated through the second arm waveguide 9. Likewise, the second MZI 5 delays the phase of the DQPSK signal that is propagated through the first arm waveguide 12 by the amount of delay equivalent to one bit of the symbol rate−¼π compared with the phase of the optical signal that is propagated through the second arm waveguide 13.

With the delay demodulation device 101, adjustment of the PDF or phase adjustment (phase trimming) for rendering the phase difference between the first and second MZI 4 and 5 to be π/2 is performed by driving the heater A or D on the first MZI 4 or the heater E or H on the second MZI 5. As described, the phase difference of 90 degrees between the first and second MZIs 4 and 5 may be realized by phase adjustment using a phase adjustment unit such as a heater.

### Example

Next, a 40 Gbps DQPSK delay demodulation device having the configuration illustrated in FIG. 1 was fabricated on a silicon substrate. Additionally, fabrication of a planar lightwave circuit was performed by the FHD method, photolithography and reactive ion etching. Also, fabrication was performed with the top side of the page of FIG. 1 as the orientation flat (OF) direction of the silicon substrate. Therefore, each of the couplers of the delay demodulation device of the present example was arranged on the silicon substrate with the same orientation as the arrangement A of FIG. 8.

Furthermore, four arm waveguides, i.e. first and second arm waveguides of a first MZI and first and second arm waveguides of a second MZI, were arranged close to one another at a regular interval of 40 μm at a portion where a ½ wavelength plate is to be inserted. Furthermore, grooves were formed on a cladding layer by dicing, and first and second ½ wavelength plates were inserted into the formed grooves.

Also, at the time of inserting the ½ wavelength plates into the delay demodulation device of the present example, the ½ wavelength plates were cut into 2 mm, which was half the original length, and were inserted in such a way that the middle region of each ½ wavelength plate was inserted approximately in the middle of the four arm waveguides in the longitudinal direction.

In the fabricated delay demodulation device, the difference between the refractive index of the cladding layer and the refractive index of a core of a waveguide (relative refractive-index difference Δ) was 1.2%, and miniaturization of the circuit size (the size of the PLC chip) to 13 mm×16.5 mm was realized. Also, the FSR was 23 GHz. Furthermore, the PDF was adjusted by driving one of the heaters of the first and second MZIs. After this adjustment, phase adjustment (phase trimming) was performed by driving one of the heaters of the first and second MZIs in such a way that the phase difference between the first and second MZIs was π/2. That is, this phase adjustment produces the interference characteristics in the first and second MZIs such that the phases were shifted by 90 degrees.

Also, the ½ wavelength plates were selected and used such that desirable PDF characteristics were able to be obtained in both the first and second MZIs.

Then, a fiber block having one optical fiber was connected to an edge surface of a PLC chip including an end portion of an optical input waveguide to which an optical signal was input, and a fiber array having four aligned optical fibers was connected to an edge surface of the PLC chip where there are end portions (output ports) of optical output waveguides from which optical signals of output 1 to output 4 were output, and packaging was performed. Also, for a temperature adjustment mechanism of the delay demodulation device, a Peltier element and a thermistor were used. A delay demodulation module including the delay demodulation device was fabricated in this manner.

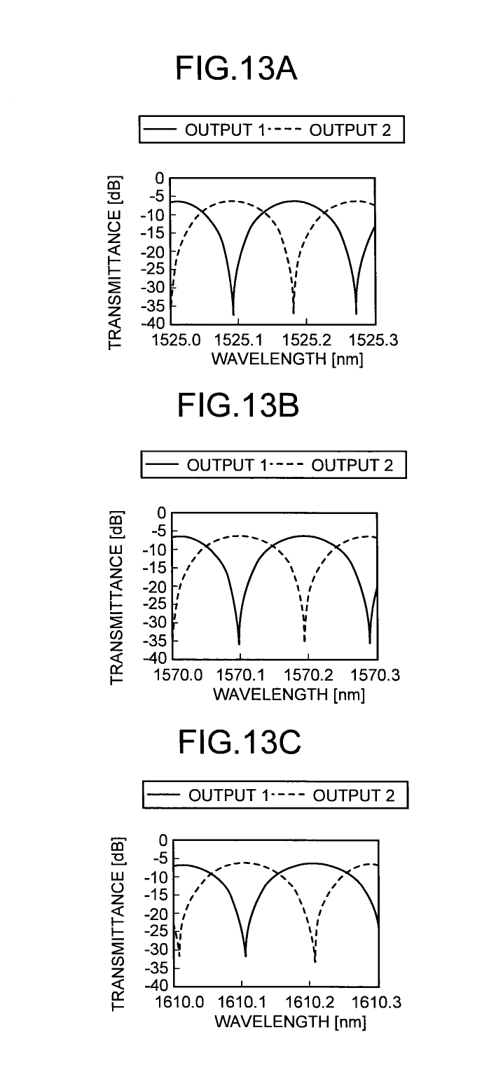

A transmission spectrum and a PDF were evaluated with respect to the fabricated delay demodulation module in a wavelength bandwidth of 1520 to 1620 nm, which is normally used in the wavelength-multiplexed optical communications. FIGS. 13A to 13C are diagrams illustrating transmission spectra near 1525 nm (FIG. 13A), near 1570 nm (FIG. 13B) and near 1610 nm (FIG. 13C) of output ports 1 and 2 (corresponding to the output ports Pout1 and Pout2 in FIG. 1) of the delay demodulation device of the present example.

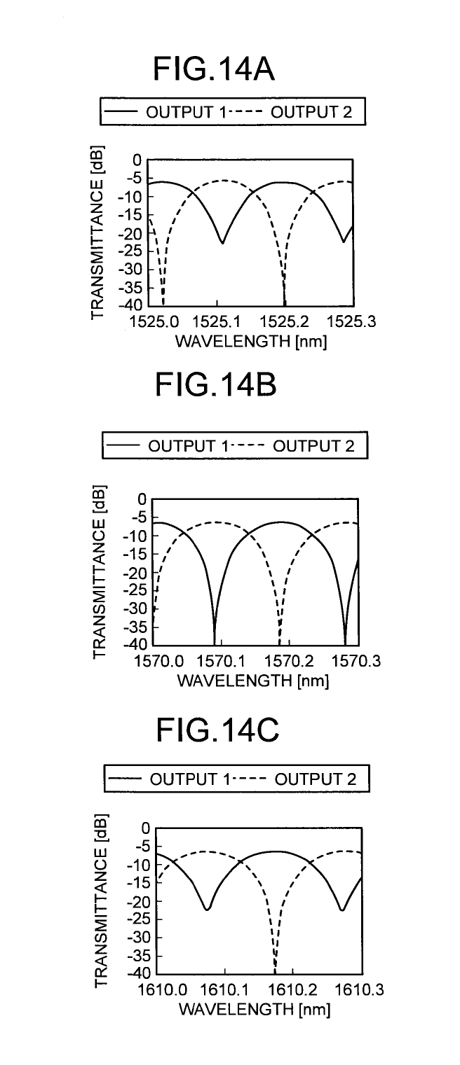

Also, as a comparative example, a delay demodulation device having a configuration according to which the optical coupler of the delay demodulation device of the example was replaced by a regular directional coupler was fabricated, and a delay demodulation module including the same was fabricated. FIGS. 14A to 14C are diagrams illustrating transmission spectra near 1525 nm (FIG. 14A), near 1570 nm (FIG. 14B) and near 1610 nm (FIG. 14C) of output ports 1 and 2 (corresponding to the output ports Pout1 and Pout2 in FIG. 1) of a delay demodulation device of a comparative example.

As illustrated in FIGS. 13A to 13C and FIGS. 14A to 14C, in the comparative example where a regular directional coupler was used, the extinction ratio (the difference between the maximum and minimum values of transmittance) of the output 1 (the through port of the first MZI) was greatly deteriorated as the wavelength deviates from near 1570 nm where the coupling ratio of the directional coupler was approximately 50%. The reason is that the extinction ratio of an MZI is generally at its highest with a wavelength of a coupler's coupling ratio being 50%, and since the coupling ratio is shifted away from 50% as the wavelength deviates from the set wavelength, the extinction ratio is deteriorated accordingly. On the other hand, when a coupler which was a WINC was used as in the present example, a high extinction ratio of 20 dB or more was obtained with any wavelength.

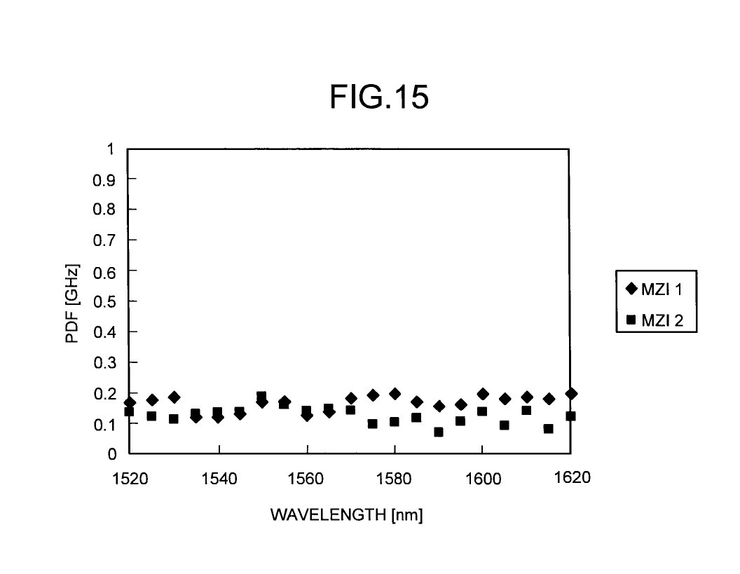

FIG. 15 is a diagram illustrating a measurement result of a PDF of each MZI of the delay demodulation device of the example in a wavelength bandwidth from 1520 to 1620 nm. Additionally, an MZI 1 indicates a first MZI, and an MZI 2 indicates a second MZI. As illustrated in FIG. 15, the PDF is 0.2 GHz or less throughout the entire band for both of the MZIs, and desirable characteristics were obtained.

It can be confirmed from this result that, by using the WINCs as the input coupler and the output coupler of the MZI of the delay demodulation device, a wavelength bandwidth where a high extinction ratio of 20 dB or more is attainable is able to be widened.

Evaluation of Influence of Optical Coupler Arrangement on Coupling Efficiency

Next, to check the difference in the characteristics of MZIs due to the arrangement of optical couplers which are WINCs, MZIs of the arrangements A to D illustrated in FIGS. 6A to 6D were fabricated, and their transmission spectra were measured.

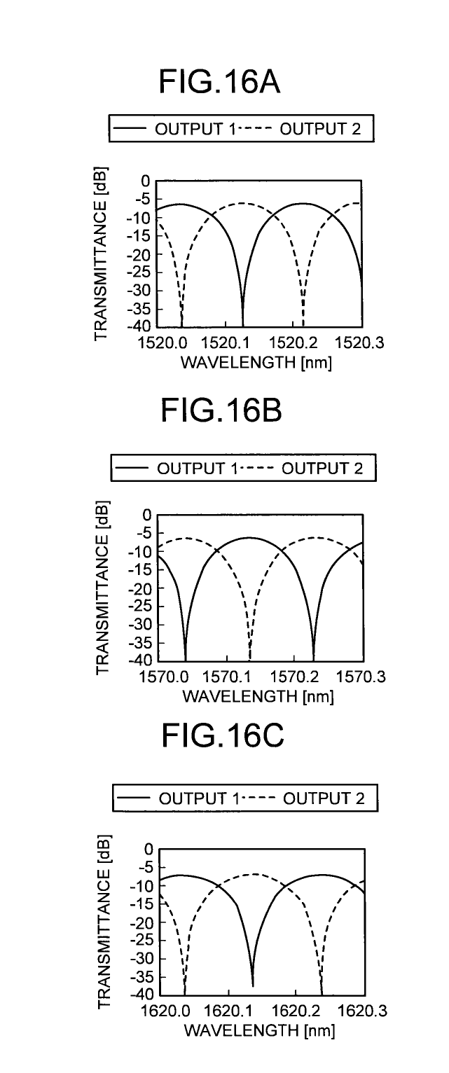

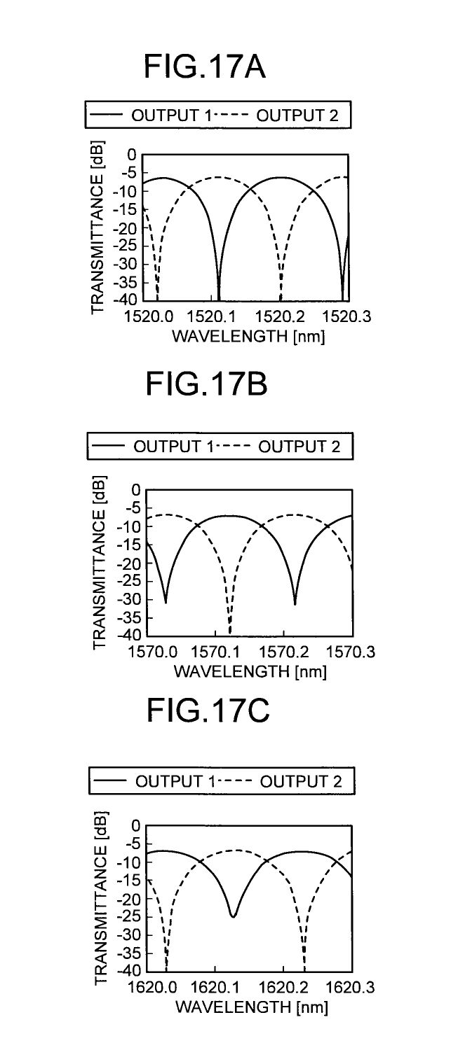

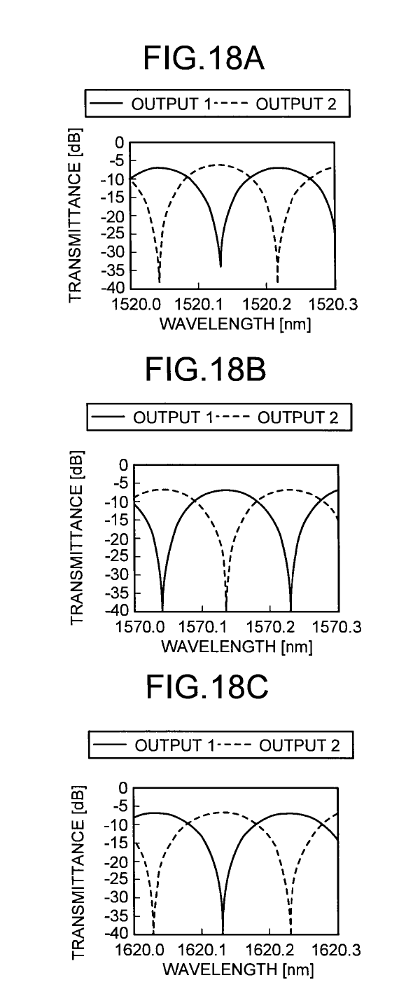

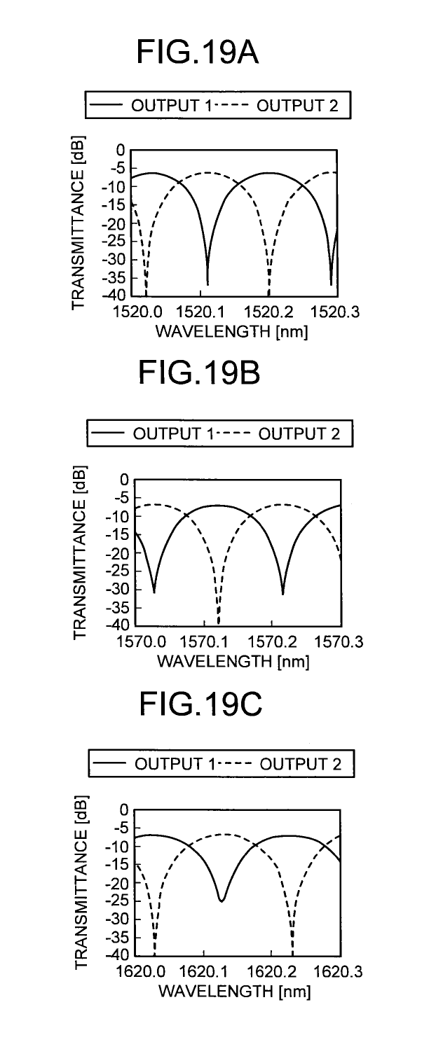

FIGS. 16A to 16C are diagrams illustrating transmission spectra near 1520 nm (FIG. 16A), near 1570 nm (FIG. 16B) and near 1620 nm (FIG. 16C) of output ports 1 and 2 (a through port and a cross port) of the MZI of the arrangement A illustrated in FIG. 6A. FIGS. 17A to 17C are diagrams illustrating transmission spectra near 1520 nm (FIG. 17A), near 1570 nm (FIG. 17B) and near 1620 nm (FIG. 17C) of output ports 1 and 2 (a through port and a cross port) of the MZI of the arrangement B illustrated in FIG. 6B. FIGS. 18A to 18C are diagrams illustrating transmission spectra near 1520 nm (FIG. 18A), near 1570 nm (FIG. 18B) and near 1620 nm (FIG. 18C) of output ports 1 and 2 (a through port and a cross port) of the MZI of the arrangement C illustrated in FIG. 6C. FIGS. 19A to 19C are diagrams illustrating transmission spectra near 1520 nm (FIG. 19A), near 1570 nm (FIG. 19B) and near 1620 nm (FIG. 19C) of output ports 1 and 2 (a through port and a cross port) of the MZI of the arrangement D illustrated in FIG. 6D.

As illustrated in FIGS. 16A to 16C and FIGS. 18A to 18C, with the arrangements A and C, a high extinction ratio of 20 dB or more was obtained with any wavelength. On the other hand, as illustrated in FIGS. 17A to 17C and FIGS. 19A to 19C, with the arrangements B and D, there were wavelengths where the extinction ratio was deteriorated to below 20 dB.

It can be confirmed from this result, as with the arrangements A and C, that the usable wavelength band is able to be widened by causing to be the same the side on which a first waveguide with a long waveguide length is arranged with respect to the longitudinal direction of the input coupler and the side on which a first waveguide with a long waveguide length is arranged with respect to the longitudinal direction of the output coupler.

Estimation of Loss Due to Crossing of Waveguides

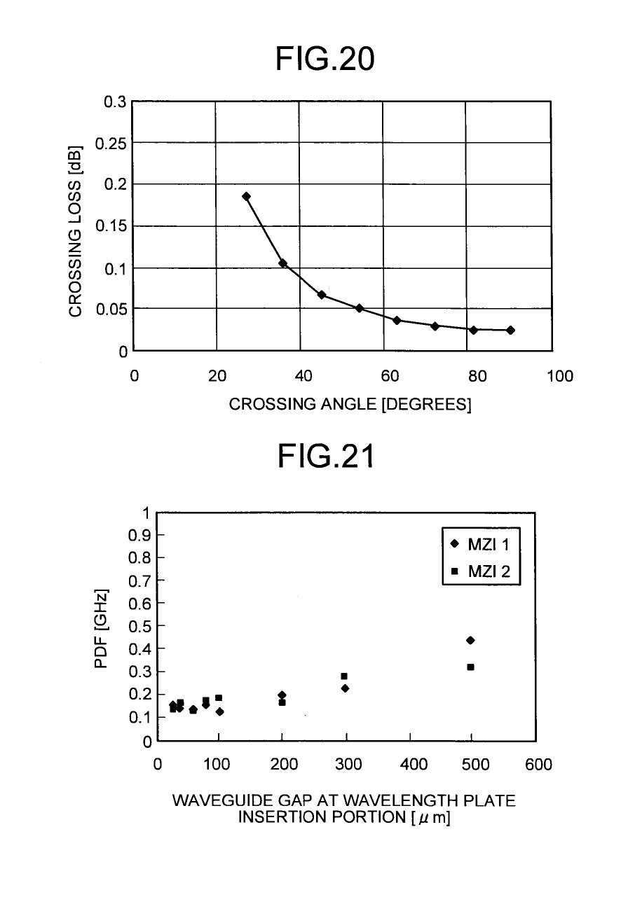

As described above, in the first embodiment and the example, two arm waveguides cross each other and light (a DQPSK signal) that is propagated through each of the two arm waveguides is propagated through the same arm waveguide after passing through the crossing point, and at this time, a loss occurs. Accordingly, to estimate the loss due to the crossing of the waveguides, crossed waveguides for testing having various crossing angles were fabricated using the same waveguides as the delay demodulation device of the example (the size of the waveguide is 6 μm×6 μm, Δ=1.2%) and the insertion losses were measured to thereby obtain the relationship of a crossing angle and the crossing loss per one crossing point. FIG. 20 is a diagram illustrating a relationship between the crossing angle and the crossing loss. As can be seen from FIG. 20, when the crossing angle at a crossing point is approximately 35 degrees or more, the crossing loss is 0.1 dB or less, and thus, propagation through the same waveguide with approximately no loss can be assumed.

Next, the result of FIG. 20 and the result of obtaining the loss due to the crossing of arm waveguides with the crossing angle at the crossing point (corresponding to the crossing point 62 or 64 in FIG. 1) of the arm waveguides being 63 degrees are shown in Table 3. Additionally, the crossing points are indicated by the reference numerals of FIG. 1. As shown in Table 3, the crossing loss at each crossing point is merely 0.04 dB, and accordingly, the loss caused by the crossing of the arm waveguides (reference numerals 9 and 12) is quite small, being 0.08 dB.

TABLE 3

| Crossing | | | | | | | | |
|---|---|---|---|---|---|---|---|---|
| point/arm | Crossing point | | | | Arm | | | |
| Reference | 62, 64 | — | — | — | 8 | 9 | 12 | 13 |
| numeral | | | | | | | | |
| Crossing | 63 | — | — | — | — | — | — | — |
| angle | | | | | | | | |
| [degrees] | | | | | | | | |
| Crossing | 0.04 | — | — | — | 0.0 | 0.08 | 0.08 | 0.0 |
| loss [dB] | | | | | | | | |

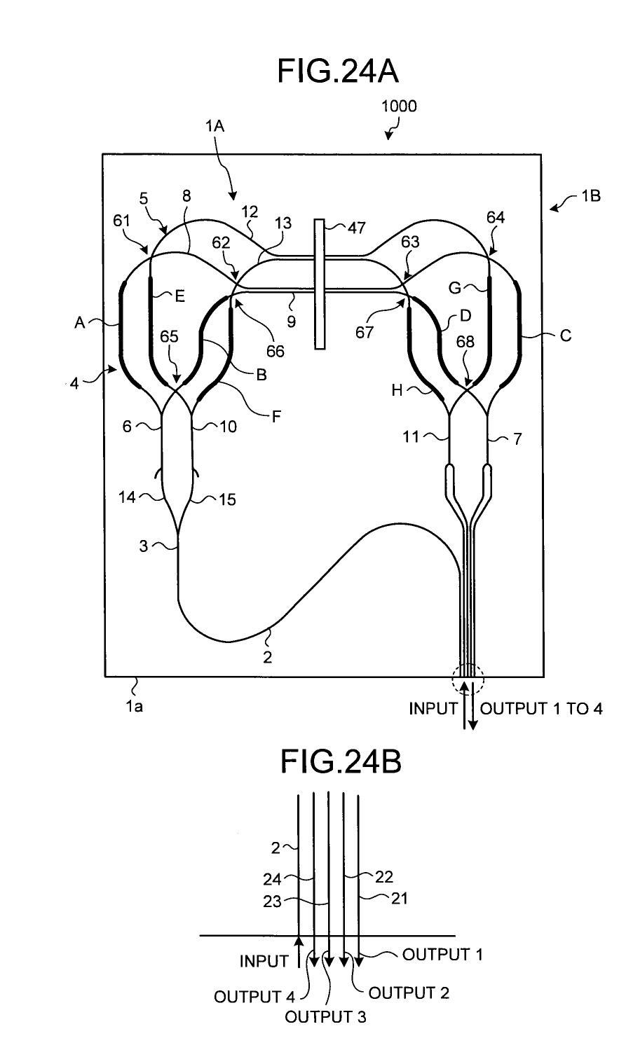

As a comparison, the result of obtaining a loss due to crossing for a conventional delay demodulation device disclosed in JP 4615578 B1 is shown in Table 4. FIG. 24A is a planar view illustrating a schematic configuration of the conventional delay demodulation device. FIG. 24B is an enlarged view of input/output ends (dashed line parts) of the delay demodulation device illustrated in FIG. 24A. Additionally, the structural elements of a delay demodulation device 1000 corresponding to the structural elements of the delay demodulation device 101 of the first embodiment are denoted with the same reference numerals. Also, in contrast to the delay demodulation device 101, this delay demodulation device 1000 further includes crossing points 61, 63, 65, 66, 67 and 68. According to Tables 3 and 4, the delay demodulation device 101 of the present first embodiment has succeeded in greatly reducing the crossing points of the waveguides compared with the delay demodulation device 1000, and as a result, in reducing the crossing loss for each arm waveguide.

TABLE 4

| Crossing | | | | | | | | |
|---|---|---|---|---|---|---|---|---|
| point/arm | Crossing point | | | | Arm | | | |
| Reference | 61, 64 | 62, 63 | 65, 68 | 66, 67 | 8 | 9 | 12 | 13 |
| numeral | | | | | | | | |
| Crossing | 47 | 77 | 88 | 47 | — | — | — | — |
| angle | | | | | | | | |
| [degrees] | | | | | | | | |
| Crossing | 0.07 | 0.03 | 0.03 | 0.07 | 0.2 | 0.2 | 0.2 | 0.2 |
| loss [dB] | | | | | | | | |

Evaluation of Relationship Between Arm Waveguide Interval and PDF

Next, to evaluate the gap between the arm waveguides at a part where a ½ wavelength plate is to be inserted (a ½ wavelength plate insertion portion) and a PDF, delay demodulation devices, having the configuration illustrated in FIG. 1, where the gaps of the four arm waveguides, i.e. the first and second arm waveguides of the first MZI and the first and second arm waveguides of the second MZI, at the ½ wavelength plate insertion portion are 30 μm, 40 μm, 60 μm, 80 μm, 100 μm, 200 μm, 300 μm and 500 μm, were fabricated, and the PDFs of the fabricated delay demodulation device were evaluated. For any of the delay demodulation devices, two ½ wavelength plates were inserted in such a manner that the middle regions were inserted approximately in the middle in the longitudinal direction of the four arm waveguides.

FIG. 21 is a diagram illustrating a relationship between a waveguide interval and a PDF. As illustrated in FIG. 21, the PDF is deteriorated as the waveguide interval is widened, and particularly, the PDF is 0.3 GHz or more where the gap is 300 μm or more. Also, based on FIG. 21, in the delay demodulation device 101, the waveguide intervals at the middle portions of the arm waveguides 8, 9, 12 and 13, more particularly, the waveguide intervals at the ½ wavelength plate insertion portions where the ½ wavelength plates 47 and 70 are inserted, are preferably equal distance gaps between 30 μm and 100 μm. By setting each waveguide interval to be such a narrow gap, the influence of position dependence of polarization conversion efficiency of the ½ wavelength plate is able to be suppressed, and the PDF is able to be reduced to 0.2 GHz or less.

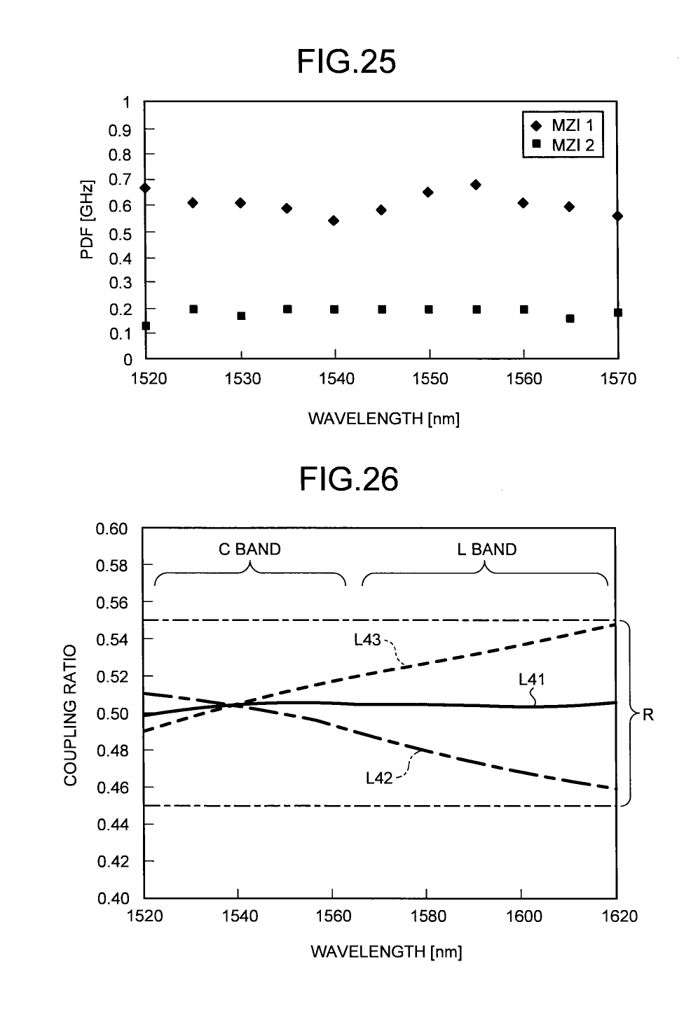

Incidentally, FIG. 25 is a diagram illustrating, with respect to the conventional delay demodulation device 1000 illustrated in FIG. 24A, the wavelength dependence of a PDF where there is a difference between the PDFs of the first and second MZIs 4 and 5 due to position dependence of the polarization conversion efficiency of the ½ wavelength plate 47. An MZI 1 indicates the first MZI 4, and an MZI 2 indicates the second MZI 5.

According the first embodiment having the configuration described above, the following effects are achieved.

The first ½ wavelength plate 47 is installed at the middle portions of the first and second arm waveguides 8 and 9 of the first MZI 4 and the first and second arm waveguides 12 and 13 of the second MZI 5 in such a way as to cross with all the four arm waveguides 8, 9, 12 and 13, and the four arm waveguides 8, 9, 12 and 13 come close to one another at the position where the first ½ wavelength plate 47 is inserted.

According to this configuration, since all of the four arm waveguides 8, 9, 12 and 13 pass through a narrow region, that is, the first ½ wavelength plate 47, the influence of the position dependence of the polarization conversion efficiency of the first ½ wavelength plate 47 is unlikely to be exerted, and thus, desirable characteristics are more easily realized for both of the first and second MZIs 4 and 5. Also, the cost is able to be reduced.

Specifically, (1) since all of the four arm waveguides are to pass through only a narrow region, that is, the ½ wavelength plate, the influence of the position dependence of the polarization conversion efficiency of the wavelength plate is able to be suppressed, and the polarization dependence is able to be reduced. That is, both of the influence of the position dependence of the polarization conversion efficiency of the first ½ wavelength plate 47 at the crossing position with the two arm waveguides of the first and second MZIs 4 and 5 and the influence of the position dependence of the polarization conversion efficiency of the wavelength plate at between the positions of the two arm waveguides of the first MZI 4 and the positions of the two arm waveguides of the second MZI 5 is able to be suppressed. The polarization dependence is able to thereby be reduced. (2) Also, desirable part of the first ½ wavelength plate 47 may be used for both the first and second MZIs 4 and 5, and thus, desirable characteristics are able to be obtained for both the first and second MZIs 4 and 5 at the same time. (3) A first ½ wavelength plate 47 of a small size may be used, and the cost is able to be reduced.

Similarly, the first ½ wavelength plate 70 is installed at the first and second arm waveguides 8 and 9 of the first MZI 4 and the first and second arm waveguides 12 and 13 of the second MZI 5 in such a way as to cross with all the four arm waveguides 8, 9, 12 and 13, and the four arm waveguides 8, 9, 12 and 13 come close to one another at the position where the first ½ wavelength plate 70 is inserted. According to this configuration, the influence of the position dependence of the polarization conversion efficiency of the second ½ wavelength plate 70 is hardly exerted on the four arm waveguides 8, 9, 12 and 13, and desirable characteristics are able to be easily realized for both the first and second MZIs 4 and 5. Also, the cost is able to be reduced.

In the planar lightwave circuit 1A, each of the arm waveguides of the first and second MZIs 4 and 5 are arranged so as to overlap one another in the same region, and the second arm waveguide 9 of the first MZI 4 and the first arm waveguide 12 of the second MZI 5 cross each other at both sides of the first and second wavelength plates 47 and 70, that is, at the crossing points 62 and 64. Also, the waveguides at the ½ wavelength plate insertion portion are arranged in the order of the first arm waveguide 8 of the first MZI 4, the first arm waveguide 12 of the second MZI 5, the second arm waveguide 9 of the first MZI 4, and the second arm waveguide 13 of the second MZI 5 such that an arm waveguide of one MZI is arranged between the arm waveguides of the other MZI, and thus, the waveguide intervals between at the ½ wavelength plate insertion portion are able to be narrowed with the minimum number of crossing points, and characteristics of low loss and low PDF are able to be obtained.

The optical path length 11 of the second arm waveguide 9, which is the shorter arm waveguide of the first MZI 4, and the optical path length 12 of the second arm waveguide 13, which is the shorter arm waveguide of the second MZI 5, are made different from each other, and optical path lengths 121 and 122 from the Y-branch waveguide 3 to the output side (the output ports Pout1 and Pout2 of the optical output waveguides 21 and 22) of the first MZI 4 via the second arm waveguide 9 of the first MZI 4 and the optical path lengths 123 and 124 from the Y-branch waveguide 3 to the output side (the output ports Pout3 and Pout4 of the optical output waveguides 23 and 24) of the second MZI 5 via the second arm waveguide 13, which is the shorter arm waveguide of the second MZI 5, are made approximately the same. Accordingly, the degree of freedom of design is increased, thereby allowing a compact arrangement with a smaller number of crossings than where the second arm waveguide 9 and the second arm waveguide 13 are formed with the same optical path length.

Since miniaturization of the PLC chip 1B is realized, the uniformity of the temperature distribution on the surface of the planar lightwave circuit 1A is improved, and the shift of the center wavelength of the wavelength characteristics due to the change in the ambient temperature is able to be made quite small.

Also, since miniaturization of the PLC chip 1B is realized, the stress distribution on the surface of the PLC chip 1B which may induce birefringence is reduced, and the shift of the center wavelength of the wavelength characteristics due to the change in the ambient temperature is able to be made quite small. Accordingly, a delay demodulation device which includes approximately no wavelength shift in the wavelength characteristics with respect to a change in the ambient temperature and whose initial PDF is small is able to be obtained.

Furthermore, with the miniaturization of the PLC chip 1B, a delay demodulation module using the delay demodulation device 101 is able to be miniaturized or low power consumption is able to be achieved.

The first MZI 4 and the second MZI 5 are formed left-right symmetrical on the PLC substrate 30, and further miniaturization of the PLC chip 1B and further reduction in the PDF are enabled.

Since the heaters A to H are formed on the two arm waveguides on each of the first and second MZIs 4 and 5, the PDF is able to be adjusted by driving one of the heaters of the first and second MZIs 4 and 5. After this adjustment, phase adjustment (phase trimming) is performed by driving one of the heaters of the first and second MZIs 4 and 5 in such a way that the phase difference between the two MZIs is π/2.

### Second Embodiment

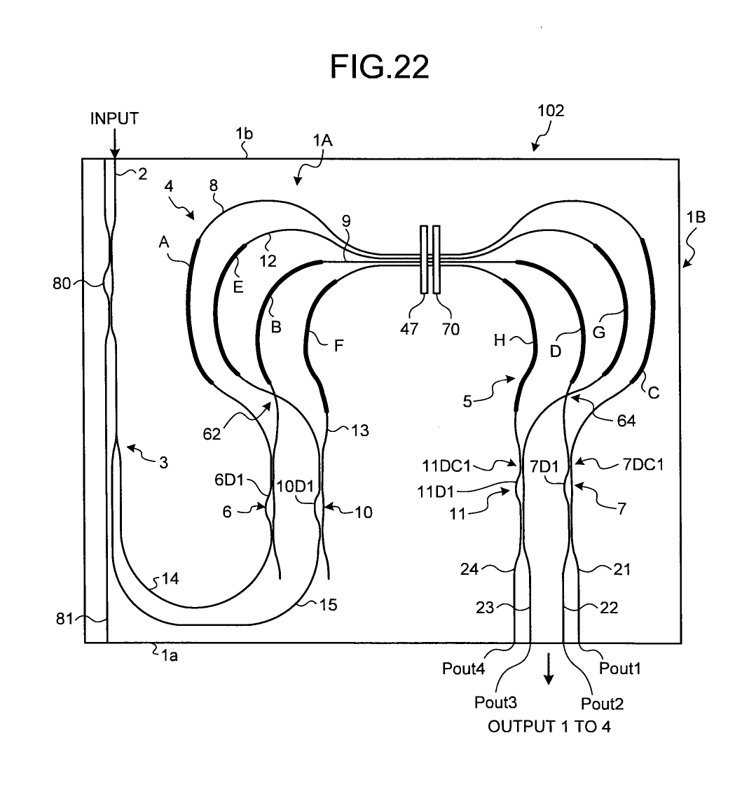

FIG. 22 is a planar view illustrating a schematic configuration of a PLC demodulating delay circuit (a delay demodulation device) according to a second embodiment. As illustrated in FIG. 22, a delay demodulation device 102 according to the second embodiment is different from the delay demodulation device 101 according to the first embodiment in the arrangement of output couplers 7 and 11, and is the same as the delay demodulation device 101 in other aspects.

That is, according to the delay demodulation device 102, a directional coupler 7DC1 is arranged on the side of first and second waveguides 8 and 9, with respect to the arrangement of the output coupler 7, as with the arrangement C in FIG. 6C. Also, a first waveguide 7D1 with a long optical path length is arranged on the left side on the page with respect to the longitudinal direction of the output coupler 7. That is, the side on which a first waveguide 6D1 is arranged with respect to the longitudinal direction of an input coupler 6 and the side on which the first waveguide 7D1 is arranged with respect to the longitudinal direction of the output coupler 7 are the same. The input coupler 6 and the output coupler 7 are arranged such that if either is line-symmetrically moved with respect to a line drawn on the page, between the input coupler 6 and the output coupler 7, along the longitudinal direction, and then is rotated 180 degrees, they will coincide with each other. Furthermore, with respect to the arrangement of the output coupler 11, a directional coupler 11DC1 is arranged on the side of first and second arm waveguides 12 and 13. Also, a first waveguide 11D1 with a long optical path length is arranged on the left side on the page with respect to the longitudinal direction of the output coupler 11. That is, the side on which a first waveguide 10D1 is arranged with respect to the longitudinal direction of an input coupler 10 and the side on which the first waveguide 11D1 is arranged with respect to the longitudinal direction of the output coupler 11 are the same. The input coupler 10 and the output coupler 11 are arranged such that if either is line-symmetrically moved with respect to a line drawn on the page, between the input coupler 10 and the output coupler 11, along the longitudinal direction, and then is rotated 180 degrees, they will coincide with each other.

Also with the delay demodulation device 102 according to the present second embodiment, flat wavelength characteristics where the coupling ratio κ is 50% plus or minus 2% between 1520 nm and 1620 nm is obtained with respect to each of the input couplers 6 and 10 and the output couplers 7 and 11, as in the arrangements A and C in FIG. 8. As a result, the delay demodulation device 102 is able to realize desirable characteristics according to which the extinction ratio is 20 dB or more over a wide wavelength bandwidth of 1520 to 1620 nm.

### Third Embodiment

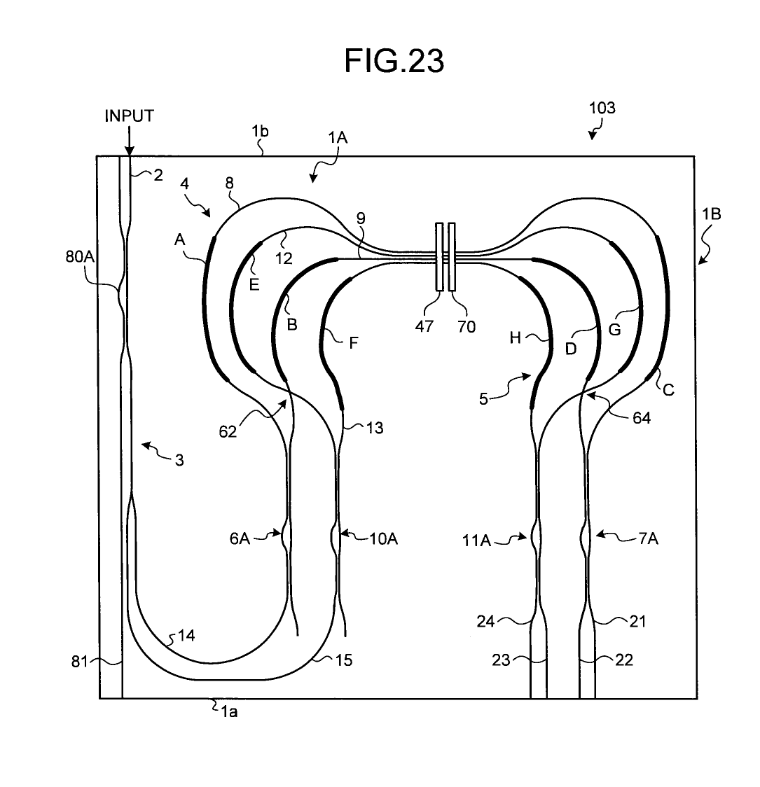

FIG. 23 is a planar view illustrating a schematic configuration of a PLC demodulating delay circuit (a delay demodulation device) according to a third embodiment. As illustrated in FIG. 23, a delay demodulation device 103 according to the third embodiment is the delay demodulation device 102 according to the second embodiment with the tap coupler 80, the input couplers 6 and 10, and the output couplers 7 and 11 replaced by a tap coupler 80A, input couplers 6A and 10A, and output couplers 7A and 11A, and the delay demodulation device 103 is the same as the delay demodulation device 102 in other aspects.

The input couplers 6A and 10A, and the output couplers 7A and 11A are different from the input couplers 6 and 10, and the output couplers 7 and 11 in that they are 50 percent WINCs having the circuit parameters shown in Table 5, for example, and in that their waveguide widths do not become narrow at the DC coupling unit. Also, the tap coupler 80A is different from the tap coupler 80 in that it is a 5 percent WINC having the circuit parameters shown in Table 6, for example, and in that its waveguide width does not become narrow at the DC coupling unit.

TABLE 5

| | |
|---|---|
| Item | Value |

| | | |
|---|---|---|
| Waveguide width | Input/output unit | 6 μm |
| | ΔL portion | 6 μm |
| | DC coupling unit | 6 μm |
| Length of DC coupling unit | DC1 | 1000 μm |
| | DC2 | 2070 μm |
| DC coupling ratio | DC1 | About 50% |
| | DC2 | About 100% |

| | |
|---|---|
| Waveguide length difference ΔL | 0.36 μm |

TABLE 6

| | |
|---|---|
| Item | Value |

| | | |
|---|---|---|
| Waveguide width | Input/output unit | 6 μm |
| | ΔL portion | 6 μm |
| | DC coupling unit | 6 μm |
| Length of DC coupling unit | DC1 | 240 μm |
| | DC2 | 420 μm |
| DC coupling ratio | DC1 | About 5% |
| | DC2 | About 10% |

| | |
|---|---|
| Waveguide length difference ΔL | 0.65 μm |

The DC coupling unit configuring the tap coupler 80A, the input couplers 6A and 10A, and the output couplers 7A and 11A is not narrow in its waveguide width, and thus is long. As a result, the delay demodulation device 103 illustrated in FIG. 23 is larger by, for example, approximately 2.5 mm in the vertical direction of the page compared with the delay demodulation device 101 illustrated in FIG. 1. However, with the tap coupler 80A, the input couplers 6A and 10A, and the output couplers 7A and 11A, since the waveguide width of the DC coupling unit is not made narrow, there is no optical radiation loss at a narrowed portion. As a result, the insertion loss is able to be made small, to 0.2 dB, for example, for the delay demodulation device 103 compared with the delay demodulation device 101.

Additionally, other characteristics of the delay demodulation device 103 are the same as those of the delay demodulation device 101.

In each of the embodiments described above, the side on which the first waveguide is arranged with respect to the longitudinal direction of the input coupler and the side on which the first waveguide is arranged with respect to the longitudinal direction of the output coupler are the same, both being on the left side on the page, but they may also be arranged on the right side on the page as long as they are on the same side. In this case, when they are both on the right side on the page, the circuit parameters (particularly, ΔL) of the input coupler and the output coupler may be adjusted and the coupling ratios may be corrected such that characteristics according to which the coupling ratios are 50% plus or minus 5% are able to be obtained over a wide wavelength range.

Regarding a coupling ratio correction method, a change in the coupling ratio of a WINC when ΔL is changed is illustrated in FIG. 26 based on the parameters shown in Table 5. In FIG. 26, a range R is a range where the coupling ratio is 50% plus or minus 5%. A line L41 shows characteristics where ΔL is 0.36 μm as according to Table 5. A line L42 shows characteristics where ΔL is (0.36−0.03) μm. A line L43 shows characteristics where ΔL is (0.36+0.03) μm.

As is seen from FIG. 26, when ΔL is changed, the inclination of the coupling ratio with respect to the wavelength changes. Accordingly, the inclination of the coupling ratio is able to be corrected by adjusting ΔL according to the inclination of the measured coupling ratio in such a way as to increase ΔL when the actual measured value of the coupling ratio is inclined to fall toward the long wavelength side.

Furthermore, for example, in each of the embodiments described above, with respect to the first and second MZIs, the side on which the first waveguide is arranged with respect to the longitudinal direction of each input coupler and the side on which the first waveguide is arranged with respect to the longitudinal direction of each output coupler are all on the left side on the page. That is, the side on which the first waveguide is arranged is the same for all of the four input couplers and output couplers. However, the present invention is not limited to be such, and for example, the side on which the first waveguide is arranged with respect to the longitudinal direction of the input coupler and the side on which the first waveguide is arranged with respect to the longitudinal direction of the output coupler may be the left side on the page for the first MZI, and the side on which the first waveguide is arranged with respect to the longitudinal direction of the input coupler and the side on which the first waveguide is arranged with respect to the longitudinal direction of the output coupler may be the right side on the page for the second MZI. That is, in the present invention, the side on which the first waveguide is arranged is made the same for the input coupler and the output coupler in the same optical interferometer, but the side on which the first waveguide of a coupler is arranged may be different for different optical interferometers.

Also, the circuit parameters of the WINC in each of the embodiments described above are only examples, and they may be changed as appropriate so that a desired coupling efficiency is obtained.

Furthermore, in each of the embodiments described above, if an intensity monitor for input signal light is not necessary, the tap couplers 80 and 80A may be omitted.

Furthermore, in each of the first and second embodiments, the waveguide widths of the input coupler, the output coupler and the tap coupler all become narrow at a part where optical coupling of both the first and second directional couplers (or the third and fourth directional couplers) occurs, but the waveguide width may be made narrow at a part where optical coupling of one of the first and second directional couplers (or one of the third and fourth directional couplers) occurs.

Furthermore, in each of the embodiments described above, the Y-branch waveguide 3 is used as the optical divider, but any coupler may be used as long as input light is able to be approximately equally divided, and various couplers such as a directional coupler and a multi-mode interferometer coupler may be used, for example. Incidentally, the split ratio preferably does not change much over a wide range. Moreover, each of the embodiments described above is a DQPSK delay demodulation device, but if a DPSK delay demodulation device is to be constructed, configurations of the optical divider, the second MZI, and related configurations may be omitted.

Also, in each of the embodiments described above, two wavelength plates, the first ½ wavelength plate 47 and the second ½ wavelength plate 70, are inserted as the preferred embodiment. However, the present invention is not limited to be such, and depending on the birefringence of a waveguide, the amount of occurrence of polarization conversion of a coupler, the polarization conversion efficiency of a ½ wavelength plate, or the like, a configuration is possible where only the first ½ wavelength plate 47 is inserted. Also, two ¼ wavelength plates may be inserted instead of a ½ wavelength plate.

Moreover, the present invention is not limited by the embodiments described above. Those which are configured by combining the structural elements described above as appropriate are also included in the present invention. For example, each of the couplers of the delay demodulation device 101 according to the first embodiment may be replaced by the coupler of the third embodiment with a uniform waveguide width. Moreover, other embodiments, examples, applications and the like achieved by those skilled in the art and the like based on the embodiments described above are all included in the present invention.

According to an embodiment of the disclosure, an effect that a demodulating delay circuit with a high extinction ratio over a wide wavelength bandwidth and an optical receiver is able to be realized is achieved.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A demodulating delay circuit in which a planar lightwave circuit that demodulates an optical signal that has been phase-modulated is formed, comprising:
a first optical interferometer including a two-input two-output input coupler, a two-input two-output output coupler, a first arm waveguide connecting the input coupler and the output coupler, and a second arm waveguide having an optical path length shorter than that of the first arm waveguide, the optical interferometer configured to cause interference by delaying each bit of the optical signal that has been input by approximately one bit such that the delayed bit interferes with a bit adjacent thereto, wherein
the first optical interferometer has a bent form such that a propagation direction of light in the input coupler differs from a propagation direction of light in the output coupler by approximately 180 degrees,
the input coupler and the output coupler each include a first waveguide and a second waveguide, the first waveguide having an optical path length longer than that of the second waveguide, the first waveguide and the second waveguide being arranged in parallel at two positions in a longitudinal direction with a close distance between the first and second waveguides thereby forming a first directional coupler and a second directional coupler, the input coupler and the output coupler each configured as a wavelength insensitive coupler having a coupling ratio of approximately 50 percent in a wavelength bandwidth used, and
the first waveguide of the input coupler is arranged on the same side, with respect to a longitudinal direction of the input coupler, as that on which the first waveguide of the output coupler is arranged with respect to a longitudinal direction of the output coupler.

2. The demodulating delay circuit according to claim 1, further comprising:
a second optical interferometer like the first optical interferometer; and
an optical divider that divides the input optical signal into two and causes the divided input optical signal to be input to the first and second optical interferometers, wherein
the optical signal is a DQPSK-modulated optical signal, and the first and second optical interferometers have interference characteristics demonstrating a phase shift of 90 degrees.

3. The demodulating delay circuit according to claim 1, wherein in each optical interferometer, the input coupler and the output coupler are formed approximately equally.

4. The demodulating delay circuit according to claim 3, wherein, in each optical interferometer, the input coupler and the output coupler are arranged to coincide with each other if parallel-translated in a plane in which the planar lightwave circuit is formed.

5. The demodulating delay circuit according to claim 3, wherein, in each optical interferometer, the input coupler and the output coupler are arranged to coincide with each other if: line-symmetrically moved with respect to a line drawn in a plane in which the planar lightwave circuit is formed, the line being midway between the input coupler and the output coupler and along a longitudinal direction; and rotated by 180 degrees therefrom.

6. The demodulating delay circuit according to claim 1, wherein a width of at least one of the first and second waveguides is narrower in a portion where optical coupling of at least one of the first and second directional couplers occurs than in other portions of the at least one of the first and second waveguides.

7. The demodulating delay circuit according to claim 6, wherein the widths of the first and second waveguides are narrower in the portions where the optical coupling of the first and second directional couplers occurs than in the other portions of the first and second waveguides.

8. The demodulating delay circuit according to claim 3, further comprising:
a second optical interferometer like the first optical interferometer; and
an optical divider that divides the input optical signal into two and causes the divided input optical signal to be input to the first and second optical interferometers, wherein
the optical signal is a DQPSK-modulated optical signal, and the first and second optical interferometers have interference characteristics demonstrating a phase shift of 90 degrees, and
in the first and second optical interferometers, the first waveguides of the input couplers of the first and second optical interferometers are arranged on the same side, with respect to longitudinal directions of these input couplers, as that on which the first waveguides of the output couplers of the first and second optical interferometers are arranged with respect to longitudinal directions of the output couplers, respectively.

9. The demodulating delay circuit according to claim 6, further comprising:
a second optical interferometer like the first optical interferometer; and
an optical divider that divides the input optical signal into two and causes the divided input optical signal to be input to the first and second optical interferometers, wherein
the optical signal is a DQPSK-modulated optical signal, and the first and second optical interferometers have interference characteristics demonstrating a phase shift of 90 degrees, and
in the first and second optical interferometers, the first waveguides of the input couplers of the first and second optical interferometers are arranged on the same side, with respect to longitudinal directions of these input couplers, as that on which the first waveguides of the output couplers of the first and second optical interferometers are arranged with respect to longitudinal directions of the output couplers, respectively.

10. The demodulating delay circuit according to claim 1, further comprising:
a tap coupler that divides a part of the optical signal input to each optical interferometer.

11. The demodulating delay circuit according to claim 10, wherein
the tap coupler includes a third waveguide and a fourth waveguide, the third waveguide having an optical path length longer than that of the fourth waveguide, the third waveguide and the fourth waveguide being arranged in parallel at two positions in a longitudinal direction with a close distance between the third and fourth waveguides thereby forming a third directional coupler and a fourth directional coupler, and
the tap coupler is configured as a wavelength insensitive coupler having a coupling ratio of 20 percent or less in the wavelength bandwidth used.

12. The demodulating delay circuit according to claim 11, wherein a width of at least one of the third and fourth waveguides is narrower in a portion where optical coupling of at least one of the third and fourth directional couplers occurs than in other portions of the at least one of the third and fourth waveguides.

13. The demodulating delay circuit according to claim 12, wherein widths of the third and fourth waveguides are narrower in the portions where the optical coupling of the third and fourth directional couplers occurs than in the other portions of the third and fourth waveguides.

14. The demodulating delay circuit according to claim 3, further comprising:
a second optical interferometer like the first optical interferometer;
an optical divider that divides the input optical signal into two and causes the divided input optical signal to be input to the first and second optical interferometers; and
a wavelength plate that is inserted in a middle portion of each arm waveguide of the first and second optical interferometers to cross all of the arm waveguides, wherein all of the arm waveguides are close to one another at the middle portion,
wherein the optical signal is a DQPSK-modulated optical signal, and the first and second optical interferometers have interference characteristics demonstrating a phase shift of 90 degrees.

15. The demodulating delay circuit according to claim 6, further comprising:
a second optical interferometer like the first optical interferometer;
an optical divider that divides the input optical signal into two and causes the divided input optical signal to be input to the first and second optical interferometers; and
a wavelength plate that is inserted in a middle portion of each arm waveguide of the first and second optical interferometers to cross all of the arm waveguides, wherein all of the arm waveguides are close to one another at the middle portion,
wherein the optical signal is a DQPSK-modulated optical signal, and the first and second optical interferometers have interference characteristics demonstrating a phase shift of 90 degrees.

16. The demodulating delay circuit according to claim 10, further comprising:
a second optical interferometer like the first optical interferometer;
an optical divider that divides the input optical signal into two and causes the divided input optical signal to be input to the first and second optical interferometers; and
a wavelength plate that is inserted in a middle portion of each arm waveguide of the first and second optical interferometers to cross all of the arm waveguides, wherein all of the arm waveguides are close to one another at the middle portion,
wherein the optical signal is a DQPSK-modulated optical signal, and the first and second optical interferometers have interference characteristics demonstrating a phase shift of 90 degrees.

17. The demodulating delay circuit according to claim 14, wherein
respective arm waveguides of the first and second optical interferometers are arranged in the planar lightwave circuit to overlap each other in a same region, and the second arm waveguide of the first optical interferometer and the first arm waveguide of the second optical interferometer cross each other at two positions across the wavelength plate, and
the first arm waveguide of the second optical interferometer is arranged between the first and second arm waveguides of the first optical interferometer at the middle portion.

18. The demodulating delay circuit according to claim 15, wherein
respective arm waveguides of the first and second optical interferometers are arranged in the planar lightwave circuit to overlap each other in a same region, and the second arm waveguide of the first optical interferometer and the first arm waveguide of the second optical interferometer cross each other at two positions across the wavelength plate, and
the first arm waveguide of the second optical interferometer is arranged between the first and second arm waveguides of the first optical interferometer at the middle portion.

19. The demodulating delay circuit according to claim 16, wherein
respective arm waveguides of the first and second optical interferometers are arranged in the planar lightwave circuit to overlap each other in a same region, and the second arm waveguide of the first optical interferometer and the first arm waveguide of the second optical interferometer cross each other at two positions across the wavelength plate, and
the first arm waveguide of the second optical interferometer is arranged between the first and second arm waveguides of the first optical interferometer at the middle portion.

20. The demodulating delay circuit according to claim 14, wherein
the first arm waveguide of the first optical interferometer, the first arm waveguide of the second optical interferometer, the second arm waveguide of the first optical interferometer, and the second arm waveguide of the second optical interferometer are arranged next to one another in this order at the middle portion.

21. The demodulating delay circuit according to claim 15, wherein
the first arm waveguide of the first optical interferometer, the first arm waveguide of the second optical interferometer, the second arm waveguide of the first optical interferometer, and the second arm waveguide of the second optical interferometer are arranged next to one another in this order at the middle portion.

22. The demodulating delay circuit according to claim 16, wherein
the first arm waveguide of the first optical interferometer, the first arm waveguide of the second optical interferometer, the second arm waveguide of the first optical interferometer, and the second arm waveguide of the second optical interferometer are arranged next to one another in this order at the middle portion.

23. The demodulating delay circuit according to claim 14, further comprising two waveguides each connected to an output side of the optical divider and respectively connected to the input couplers of the first or second optical interferometer, wherein the two waveguides are each U-shaped and each include a curved waveguide.

24. The demodulating delay circuit according to claim 15, further comprising two waveguides each connected to an output side of the optical divider and respectively connected to the input couplers of the first or second optical interferometer, wherein the two waveguides are each U-shaped and each include a curved waveguide.

25. The demodulating delay circuit according to claim 16, further comprising two waveguides each connected to an output side of the optical divider and respectively connected to the input couplers of the first or second optical interferometer, wherein the two waveguides are each U-shaped and each include a curved waveguide.

26. The demodulating delay circuit according to claim 2, wherein the wavelength plate is a first ½ wavelength plate whose principal axis is tilted by 45 degrees with respect to a refractive index principal axis of each arm waveguide of the first and second optical interferometers.

27. The demodulating delay circuit according to claim 26, further comprising a second ½ wavelength plate that is inserted closer to an output side than the first ½ wavelength plate of the first and second optical interferometers, and has a principal axis parallel or horizontal with respect to the refractive index principal axis of the each arm waveguide.

28. An optical receiver comprising:
the demodulating delay circuit according to claim 1; and
a photodetector that receives, and converts into an electrical signal, an optical signal output from the demodulating delay circuit.
